(19) United States
(12) Patent Application Publication
(10) Pub. No.: US 2014/0210133 A1
(43) Pub. Date: Jul. 31, 2014

(54) PATTERN FORMING APPARATUS AND PATTERN FORMING METHOD

(71) Applicant: DAINIPPON SCREEN MFG. CO., LTD., Kyoto (JP)

(72) Inventors: Masafumi KAWAGOE, Kyoto (JP); Mikio MASUICHI, Kyoto (JP); Hiroyuki UENO, Kyoto (JP); Kazuhiro SHOJI, Kyoto (JP); Yayoi SHIBAFUJI, Kyoto (JP); Miyoshi UENO, Kyoto (JP)

(73) Assignee: DAINIPPON SCREEN MFG. CO., LTD., Kyoto (JP)

(21) Appl. No.: 14/165,839

(22) Filed: Jan. 28, 2014

(30) Foreign Application Priority Data
Jan. 30, 2013 (JP) 2013-016034
Dec. 19, 2013 (JP) 2013-262351

(51) Int. Cl. B29C 59/04

(52) U.S. Cl. CPC B29C 59/04
USPC 264/293; 425/374

(57) ABSTRACT

A pattern forming apparatus comprises: a first holder which holds a blanket carrying a pattern forming material on one surface in a horizontal posture with a carrying surface for the pattern forming material faced up; a second holder which holds a plate for patterning the pattern forming material or a substrate, to which a pattern is transferred, as a processing object such that the processing object is proximate to and facing the carrying surface of the blanket held on the first holder; and a push-up unit which partially pushes up an effective area in a central part of the blanket from a lower surface side of the blanket to bring the effective area into contact with the processing object held on the second holder and moves along the lower surface of the blanket to change a push-up position of the blanket.

### CROSS REFERENCE TO RELATED APPLICATION

The disclosure of Japanese Patent Applications enumerated below including specifications, drawings and claims is incorporated herein by reference in its entirety:

No. 2013-016034 filed on Jan. 30, 2013; and

No. 2013-262351 filed on Dec. 19, 2013.

### BACKGROUND OF THE INVENTION

1. Field of the Invention

This invention relates to a pattern forming apparatus and a pattern forming method for patterning a pattern forming material carried on a blanket by a plate or for forming a pattern by transferring a formed pattern to a substrate.

2. Description of the Related Art

A technique for bringing a blanket carrying a pattern into close contact with a substrate and transferring the pattern to the substrate is known as a technique for forming a pattern on a substrate such as a glass substrate or a semiconductor substrate. Further, a technique for pattern formation (patterning) by pressing a plate (negative plate) against a uniform film formed of a pattern forming material on a blanket surface and attaching unnecessary parts of the film to the plate to remove them so that only parts, which form a pattern, remain on the blanket is known as a technique for carrying a pattern on a blanket.

Application of a printing technique disclosed in JP07-125179A to pattern transfer is, for example, known as one of such techniques. For example, in a technique disclosed in JP2002-036499A, a plate stretched on a frame by applying a tension in one direction is arranged above a substrate while being inclined with respect to the substrate, pressed against the substrate successively from one end part by a press roller and then detached to transfer a pattern on the plate to the substrate.

The above conventional technique has room for improvement in positioning accuracy between the plate and the substrate. Specifically, in the above technique, the plate needs to be held in a state where the upper surface thereof is open to be brought into contact with the roller, and an initial gap between the plate and the substrate has to be large to a certain extent to prevent the contact of the plate with the substrate due to its own weight. Thus, a displacement tends to occur in the process of bringing the both closer and pressing them against each other from that state. Further, position alignment is possible at one end side where the substrate and the plate are proximate to each other, but is not possible at the other end side. Further, there is a possibility of gradually increasing the displacement in the process of successively pressing them from an end.

### SUMMARY OF THE INVENTION

This invention was developed in view of the above problem and an object thereof is to provide a technique capable of bringing a plate or a substrate into contact with a blanket with high positioning accuracy in a pattern forming apparatus and a pattern forming method for pattern formation by bringing the plate or the substrate into contact with the blanket.

A pattern forming apparatus according to this invention includes: a first holder which holds a blanket carrying a pattern forming material on one surface in a horizontal posture with a carrying surface for the pattern forming material faced up; a second holder which holds a plate for patterning the pattern forming material or a substrate, to which a pattern is transferred, as a processing object such that the processing object is proximate to and facing the carrying surface of the blanket held on the first holder; and a push-up unit which partially pushes up an effective area in a central part of the blanket from a lower surface side of the blanket to bring the effective area into contact with the processing object held on the second holder and moves along the lower surface of the blanket to change a push-up position of the blanket.

Further, a pattern forming method according to this invention includes: a holding step of holding a plate for patterning a pattern forming material or a substrate, to which a pattern is transferred, as a processing object such that the processing object is held in a horizontal posture and holding a blanket which carries the pattern forming material on one surface in a horizontal posture with a carrying surface for the pattern forming material faced up so as to be proximate to and facing a lower surface of the processing object; and a push-up step of partially pushing up an effective area in a central part of the blanket from a lower surface side of the blanket to bring the effective area into contact with the processing object and changing a push-up position of the blanket along the lower surface of the blanket.

In these inventions, the blanket is brought into contact with the processing object by partially pushing up the blanket from the lower surface side of the blanket arranged to face the processing object (plate or substrate) from below. In such a configuration, since the holding of the processing object arranged at an upper side is not particularly restricted, it can be held in a state where a deflection is suppressed. On the other hand, the blanket arranged at a lower side may be deflected downward due to its own weight, but it does not come into contact with the processing object upon being deflected since it is deflected in a direction away from the processing object at the upper side. Thus, by bringing the processing object and the blanket closer to each other than before, a gap between the both can be set at a very small value. Further, the processing object and the blanket can be arranged to be parallel to each other.

Accordingly, position alignment can be performed in a state where the both are proximate to each other, and a displacement between the both can be suppressed to be small due to a small relative movement amount until the both are brought into contact from the state where they are proximate to each other. Because of these, according to the present invention, the plate or the substrate as the processing object and the blanket can be brought into contact with high positional accuracy. Note that the contact of the processing object and the blanket mentioned here is a concept including the contact of the both via the pattern forming material carried on the carrying surface of the blanket.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a perspective view which shows a first embodiment of a pattern forming apparatus.

FIG. 2 is a block diagram which shows a control system of the pattern forming apparatus.

FIG. 3 is a perspective view which shows the structure of the lower stage block.

FIG. 4 is a view which shows the structure of the elevation hand unit.

FIG. 5 is a view which shows the structure of the transfer roller unit.

FIG. 6 is a view which shows the structure of the upper stage assembly.

FIG. 7 is a flow chart which shows the pattern forming process.

FIGS. 8A to 8C are views which diagrammatically show a positional relationship of each component of the apparatus in each stage of the process.

FIGS. 9A to 9C are views which diagrammatically show a positional relationship of each component of the apparatus in each stage of the process.

FIGS. 10A and 10B are views which diagrammatically show a positional relationship of each component of the apparatus in each stage of the process.

FIGS. 11A to 11C are views which diagrammatically show a positional relationship of each component of the apparatus in each stage of the process.

FIGS. 12A to 12C are views which diagrammatically show a positional relationship of each component of the apparatus in each stage of the process.

FIGS. 13A to 13C are views which diagrammatically show a positional relationship of each component of the apparatus in each stage of the process.

FIG. 14 is a view which shows a positional relationship of the plate or the substrate and the blanket.

FIGS. 15A to 15C are views which diagrammatically show a positional relationship of each component of the apparatus in each stage of the process.

FIGS. 16A to 16C are views which show the superiority of the configuration for pressing the blanket from below.

FIG. 17 is a view which shows a main part of the second embodiment of the pattern forming apparatus.

FIGS. 18A and 18B are views which show positional relationships of the lower stage, the substrate and the blanket.

FIGS. 19A to 19D are views which diagrammatically show a positional relationship of each component of the apparatus in each stage of the pattern forming process of the second embodiment.

FIGS. 20A to 20E are views which diagrammatically show a positional relationship of each component of the apparatus in each stage of the pattern forming process of the second embodiment.

FIG. 21 is a view which shows a main part of the third embodiment of the pattern forming apparatus.

FIGS. 22A and 22B are views which show the detailed structure and movements of the support hand mechanisms.

FIGS. 23A and 23B are views which show the more detailed structure of the blanket receiving member.

FIGS. 24A and 24B are views which show positional relationships of the blanket receiving members, the substrate and the blanket.

FIGS. 25A to 25C are views which diagrammatically show a positional relationship of each component of the apparatus in each stage of the pattern forming process of the third embodiment.

FIGS. 26A to 26D are views which diagrammatically show a positional relationship of each component of the apparatus in each stage of the pattern forming process of the third embodiment.

FIGS. 27A to 27D are views which show a modification of the second embodiment.

FIG. 28 is a view which shows contact positions of the blanket pressing mechanism and the transfer roller with the blanket in the modification.

### DETAILED DESCRIPTION OF THE PREFERRED EMBODIMENTS

### First Embodiment

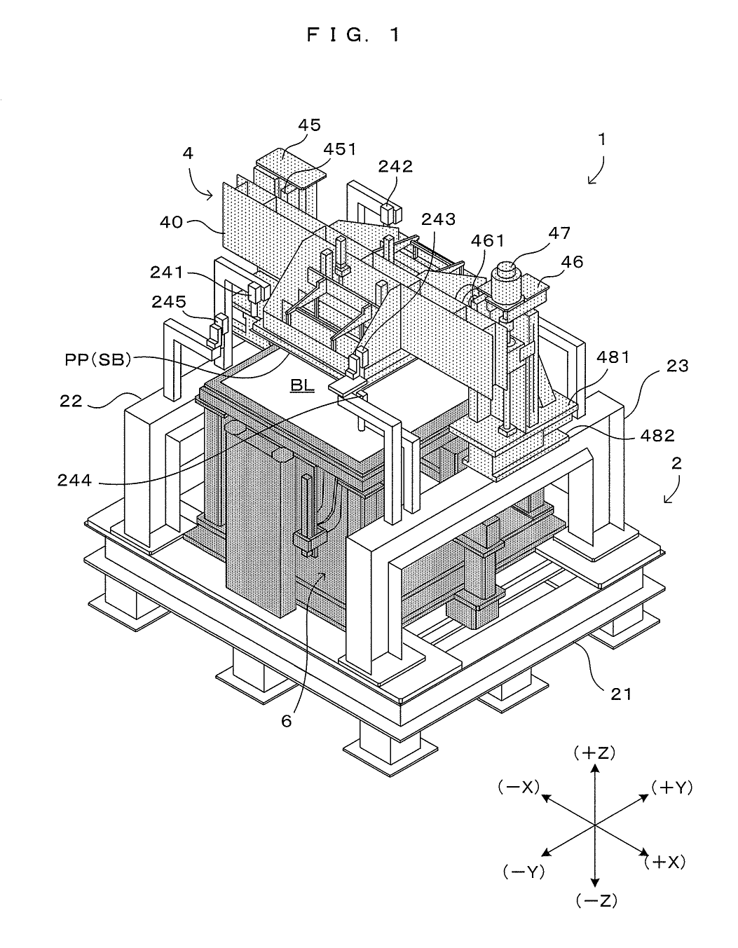

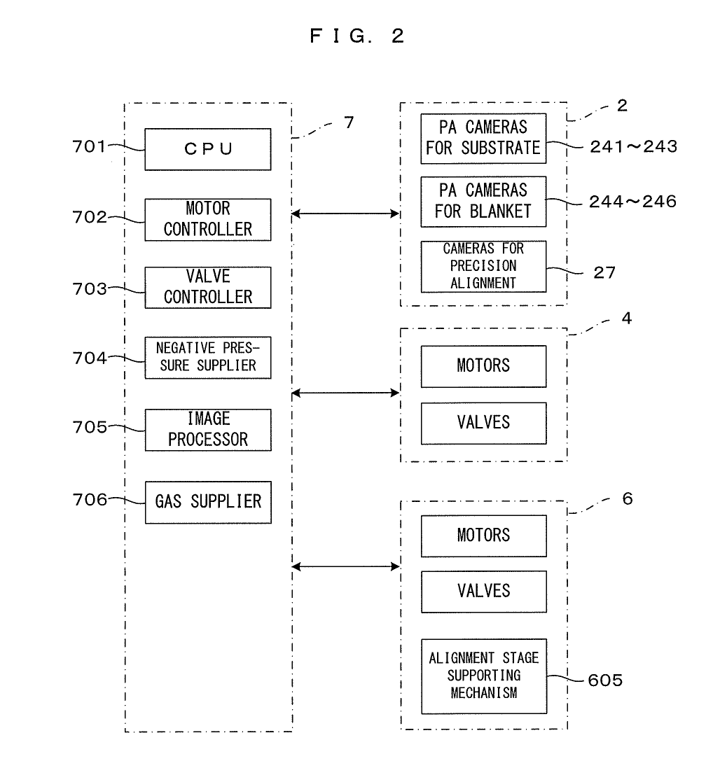

FIG. 1 is a perspective view which shows a first embodiment of a pattern forming apparatus according to this invention. FIG. 2 is a block diagram which shows a control system of this pattern forming apparatus. Note that a state where an external cover is removed to show the internal configuration of the apparatus is shown in FIG. 1. XYZ orthogonal coordinate axes are set as shown on a right lower side of FIG. 1 to show directions in each figure in a unified manner. Here, an XY plane represents a horizontal plane and a Z axis represents a vertical axis. More specifically, a (+Z) direction represents a vertically upward direction. A forward direction when viewed from the apparatus is a (−Y) direction and an access to the apparatus from the outside including loading and unloading of articles is made in a Y axis direction.

This pattern forming apparatus 1 is so structured that an upper stage block 4 and a lower stage block 6 are mounted on a main frame 2. In FIG. 1, to clarify distinction between the respective blocks, the upper stage block 4 is shown by sparse dots and the lower stage block 6 is shown by dense dots. Besides the above, the pattern forming apparatus 1 includes a control unit 7 (FIG. 2) for performing a predetermined operation by controlling each component of the apparatus in accordance with a process program stored in advance. The detailed configurations of the upper and lower stage blocks 4, 6 are described later. First, the overall configuration of the apparatus 1 is described.

The pattern forming apparatus 1 is an apparatus for pattern formation by bringing a blanket BL held by the lower stage block 6 and a plate PP or a substrate SB held by the upper stage block 4 into contact with each other. A pattern forming process by this apparatus 1 is more specifically as follows. First, the plate PP prepared in accordance with a pattern to be formed is brought into contact with the blanket BL to which a pattern forming material is evenly coated, thereby patterning a coating layer carried on the blanket BL (patterning process). Then, by bringing the thus patterned blanket BL and the substrate SB into contact with each other, the pattern carried on the blanket BL is transferred to the substrate SB (transfer process). In this way, a desired pattern is formed on the substrate SB.

As just described, this pattern forming apparatus 1 can be used in both the patterning process and the transfer process in the pattern forming process for forming a predetermined pattern on the substrate SB, but may also be used to perform only one of these processes.

The lower stage block 6 of the pattern forming apparatus 1 is supported by a base frame 21 of the main frame 2. On the other hand, the upper stage block 4 is mounted on a pair of upper stage support frames 22, 23 erected from the base frame 21 to sandwich the lower stage block 6 in an X direction and extending in a Y direction.

Further, pre-alignment cameras for detecting positions of the substrate SB and the blanket BL loaded into the apparatus are attached to the main frame 2. Specifically, three pre-alignment cameras for substrate 241, 242 and 243 for detecting edges of the substrate SB being loaded into the apparatus along the Y-axis direction at three different positions are respectively attached to booms erected from the upper stage support frames 22, 23. Similarly, three pre-alignment cameras for blanket 244, 245 and 246 for detecting edges of the blanket BL being loaded into the apparatus along the Y-axis direction at three different positions are respectively attached to booms erected from the upper stage support frames 22, 23. Note that one pre-alignment camera for blanket 246 located behind the upper stage block 4 does not appear in FIG. 1. Further, the pre-alignment cameras for substrate and the pre-alignment cameras for blanket are respectively abbreviated as “PA cameras for substrate” and “PA cameras for blanket” in FIG. 2.

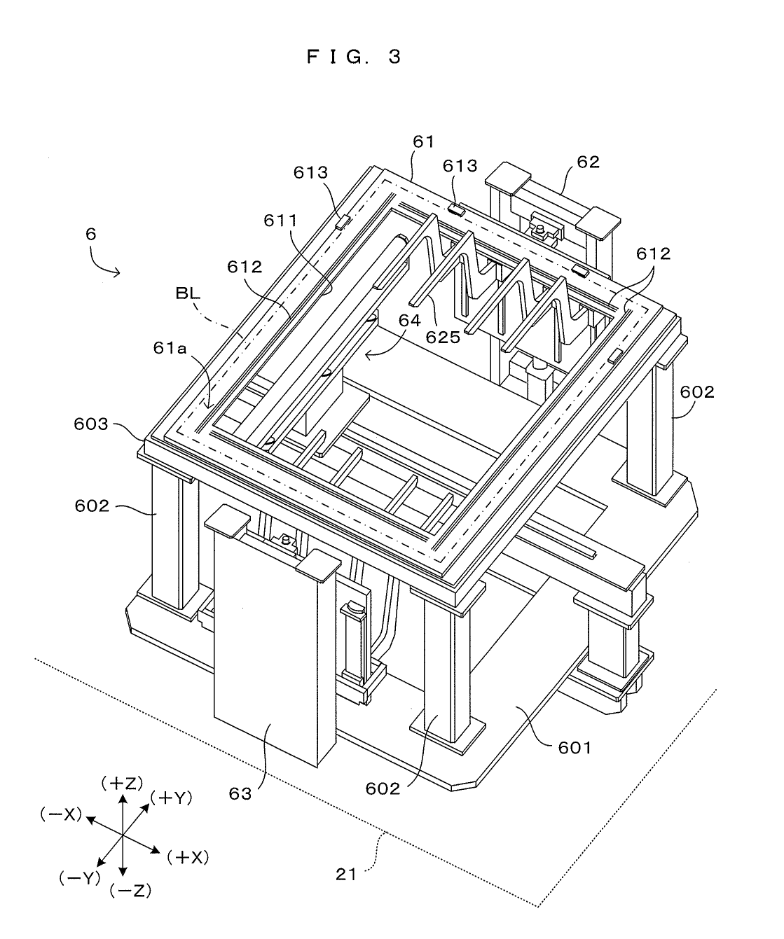

FIG. 3 is a perspective view which shows the structure of the lower stage block. In the lower stage block 6, support columns 602 stand in the vertical direction (Z direction) on four corners of a plate-like alignment stage 601 with an open central part, and a stage support plate 603 is supported by these support columns 602. Although not shown in FIG. 3, an alignment stage supporting mechanism 605 (FIG. 2) such as a cross roller bearing having three degrees of freedom in a rotation direction centered on an axis of rotation extending in the vertical direction Z (hereinafter, referred to as a “θ direction”), the X direction and the Y direction is provided below the alignment stage 601. The alignment stage 601 is mounted on the base frame 21 via this alignment stage supporting mechanism 605. Thus, the alignment stage 601 is movable in predetermined ranges in the X, Y and θ directions relative to the base frame 21 by the actuation of the alignment stage supporting mechanism 605.

An annular rectangular lower stage 61 whose upper surface is a flat surface matching a substantially horizontal plane and which is formed with an aperture window 611 in a central part is arranged above the stage support plate 603. The blanket BL is placed on the upper surface of the lower stage 61 and held by the lower stage 61.

The opening size of the aperture window 611 needs to be larger than a plane size of an effective area (described later) located in a central part of a surface area of the blanket BL and effectively functioning as a pattern forming area. In other words, when the blanket BL is placed on the lower stage 61, an area of the lower surface of the blanket BL corresponding to the effective area needs to entirely face the aperture window 611 and a lower side of the effective area needs to be completely open. The coating layer by the pattern forming material is formed to cover at least the entire effective area.

A plurality of grooves 612 are so provided on an upper surface 61a of the lower stage 61 as to extend along each side of the peripheral edge of the aperture window 611, and connected to a negative pressure supplier 704 of the control unit 7 via unillustrated control valves. Each groove 612 is arranged in a region having a plane size smaller than that of the blanket BL. As shown by dashed-dotted line in FIG. 3, the blanket BL is so placed on the lower stage 61 as to cover all of these grooves 612. To enable this, stopper members 613 for restricting the position of the blanket BL are appropriately arranged on the lower stage upper surface 61a.

The grooves 612 function as vacuum suction grooves by being supplied with the negative pressure, whereby four sides of a peripheral edge part of the blanket BL are sucked and held onto the upper surface 61a of the lower stage 61. By forming the vacuum suction grooves by the plurality of grooves 612 independent of each other, the blanket BL can be reliably held since the suction of the blanket BL by the other grooves is maintained even if vacuum breakage occurs in some of the grooves due to some cause. Further, the blanket BL can be sucked with a stronger suction force than in the case of providing a single groove.

Elevation hand units 62, 63 for vertically moving the blanket BL in the Z axis direction and a transfer roller unit 64 for coming into contact with the blanket BL from below to push it up are provided below the aperture window 611 of the lower stage 61.

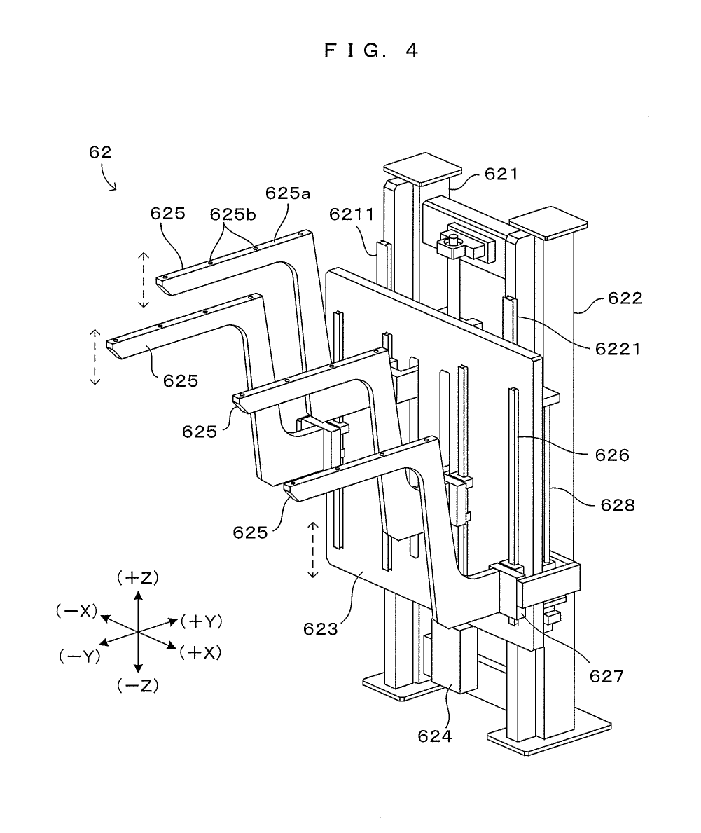

FIG. 4 is a view which shows the structure of the elevation hand unit. Since the structures of the two elevation hand units 62, 63 are identical, the structure of one elevation hand unit 62 is described here. The elevation hand unit 62 includes two support columns 621, 622 erected in the Z direction from the base frame 21. A plate-like slide base 623 is vertically movably attached to these support columns 621, 622. More specifically, guide rails 6211, 6221 extending in the vertical direction (Z direction) are respectively attached to the two support columns 621, 622, and unillustrated sliders attached on the rear surface, i.e. a (+Y) principal surface of the slide base 623 are slidably attached to the guide rails 6211, 6221. An elevation mechanism 624 provided with an appropriate driving mechanism such as a motor and a ball screw mechanism vertically moves the slide base 623 in response to a control command from the control unit 7.

A plurality of (four in this example) hands 625 are vertically movably attached to the slide base 623. The structure of each hand 625 is basically identical except in that the shape of a base part differs according to an arrangement position. Each hand 625 is fixed to a slider 627 slidably engaged with a guide rail 626 attached to the front surface, i.e. a (−Y) principal surface of the slide base 623 in the vertical direction (Z direction). The slider 627 is coupled to an elevation mechanism 628 provided with an appropriate driving mechanism such as a rodless cylinder attached to the rear surface of the slide base 623, and vertically moves relative to the slide base 623 by the actuation of the elevation mechanism 628. The independent elevation mechanism 628 is provided for each hand 625 so that each hand 625 can be individually and vertically moved.

That is, in the elevation hand unit 62, the hands 625 can be integrally elevated and lowered by vertically moving the slide base 623 by the elevation mechanism 624 and each hand 625 can be individually elevated and lowered by independently actuating each elevation mechanism 628.

An upper surface 625a of the hand 625 is finished into a long and narrow flat surface whose longitudinal direction is the Y direction, and the blanket BL is supported with the upper surface 625a held in contact with the lower surface of the blanket BL. Further, suction holes 625b communicating with the negative pressure supplier 704 provided in the control unit 7 via unillustrated pipes and control valves are provided on the upper surface 625a. This causes a negative pressure from the negative pressure supplier 704 to be supplied to the suction holes 625b if necessary and the blanket BL can be sucked and held onto the upper surface 625a of the hand 625. Thus, a slip in supporting the blanket BL can be prevented by the hands 625.

Further, appropriate gas such as dry air or inert gas is supplied to the suction holes 625b from a gas supplier 706 of the control unit 7 via unillustrated pipes and control valves if necessary. Specifically, by opening and closing each control valve controlled by the control unit 7, the negative pressure from the negative pressure supplier 704 and the gas from the gas supplier 706 are selectively supplied to the suction holes 625b.

When the gas from the gas supplier 706 is supplied to the suction holes 625b, a small amount of gas is discharged from the suction holes 625b. This causes a tiny clearance to be formed between the lower surface of the blanket BL and the hand upper surfaces 625a, and the hands 625 are separated from the lower surface of the blanket BL while supporting the blanket BL from below. Thus, the blanket BL can be horizontally moved without rubbing each hand 625 while being supported by each hand 625. Note that gas discharge holes may be provided on the hand upper surfaces 625a separately from the suction holes 625b.

Referring back to FIG. 3, in the lower stage block 6, the elevation hand units 62, 63 configured as described above are arranged to face each other in the Y direction with the hands 625 facing inward. In a state where each hand 625 is lowered most, the hand upper surface 625a is at a position largely retracted downward, i.e. in the (−Z) direction from the lower stage upper surface 61a. On the other hand, in a state where each hand 625 is elevated most, the tip of each hand 625 projects upward from the aperture window 611 of the lower stage 61 and the hand upper surface 625a reaches a position projecting further upward, i.e. in the (+Z) direction than the lower stage upper surface 61a.

Further, when viewed from above, the tips of the hands 625 of the both elevation hand units 62, 63 facing each other are spaced apart by a fixed distance and these tips do not come into contact with each other. As described next, the transfer roller unit 64 moves in the X direction utilizing this clearance.

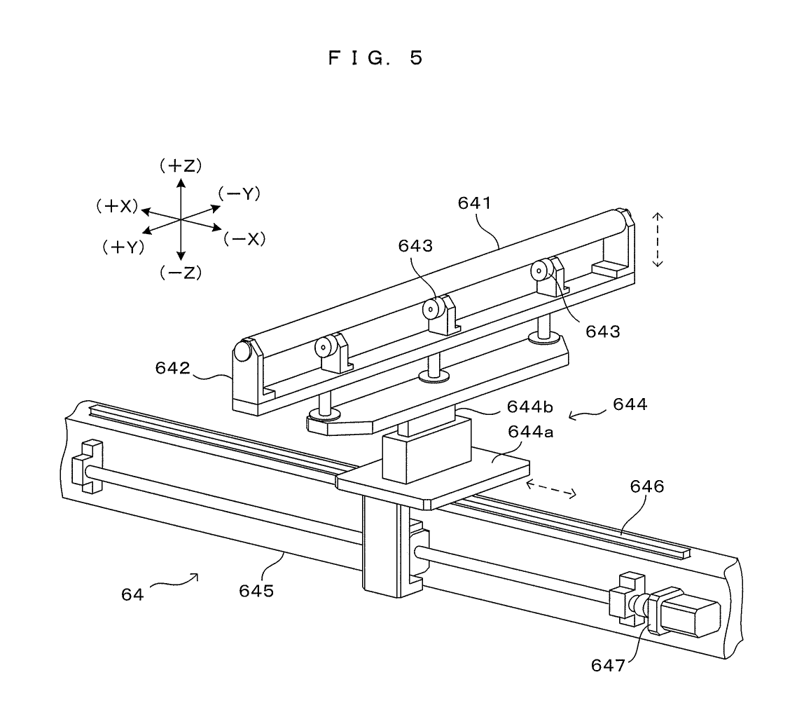

FIG. 5 is a view which shows the structure of the transfer roller unit. The transfer roller unit 64 includes a transfer roller 641 which is a cylindrical roller member extending in the Y direction, a support frame 642 which extends in the Y direction below and along the transfer roller 641 and rotatably supports the transfer roller 641 on opposite end parts thereof, and an elevating mechanism 644 which includes an appropriate driving mechanism and vertically moves the support frame 642 in the Z direction. The transfer roller 641 is not connected to a rotation driving mechanism and freely rotates. Further, backup rollers 643 for preventing the deflection of the transfer roller 641 by coming into contact with the outer surface of the transfer roller 641 are provided on the support frame 642.

A length of the transfer roller 641 in the Y direction is shorter than a length of sides extending along the Y direction out of four sides of the aperture window 611 of the lower stage 61, i.e. an opening dimension of the aperture window 611 in the Y direction and longer than a length of the plate PP or the substrate SB along the Y direction when the plate PP or the substrate SB is held by the upper stage to be described later. Since a length of the effective area of the blanket BL effective as the pattern forming area is, of course, not longer than the length of the plate PP or the substrate SB, the transfer roller 641 is longer than the effective area in the Y direction.

The elevating mechanism 644 includes a base portion 644a and a support leg 644b extending upward from the base portion 644a and coupled to the vicinity of a center of the support frame 642 in the Y direction. The support leg 644b is vertically movable relative to the base portion 644a by an appropriate driving mechanism such as a motor or a cylinder. The base portion 644a is slidably attached to the guide rail 646 extending in the X direction and coupled to a moving mechanism 647 provided with an appropriate driving mechanism such as a motor and a ball screw mechanism. The guide rail 646 extends in the X direction and is mounted on the upper surface of a lower frame 645 fixed to the base frame 21. By the actuation of the moving mechanism 647, the transfer roller 641, the support frame 642 and the elevating mechanism 644 integrally travel in the X direction.

Although described in detail later, the blanket BL is brought into contact with the plate PP or the substrate SB held by the upper stage and proximately arranged to face the blanket BL in this pattern forming apparatus 1 by bringing the transfer roller 641 into contact with the blanket BL held on the lower stage 61 and partially pushing up the blanket BL.

The elevating mechanism 644 travels through the clearances formed by the hands 625 of the elevation hand units 62, 63 facing each other. Further, each hand 625 can be retracted in the (−Z) direction until the upper surface 625a thereof reaches a position below the lower surface of the support frame 642 of the transfer roller unit 64. Accordingly, the elevating mechanism 644 travels in this state, whereby the support frame 642 of the transfer roller unit 64 passes above the upper surface 625a of each hand 625 to avoid collision of the transfer roller unit 64 and the hands 625.

Next, the structure of the upper stage block 4 is described. As shown in FIG. 1, the upper stage block 4 includes an upper stage assembly 40 which is a structure extending in the X direction, a pair of support columns 45, 46 respectively erected from the upper stage support frames 22, 23 and supporting opposite end parts of the upper stage assembly 40 in the X direction, and an elevation mechanism 47 provided with an appropriate driving mechanism such as a motor and a ball screw mechanism and configured to elevate and lower the entire upper stage assembly 40 in the Z direction.

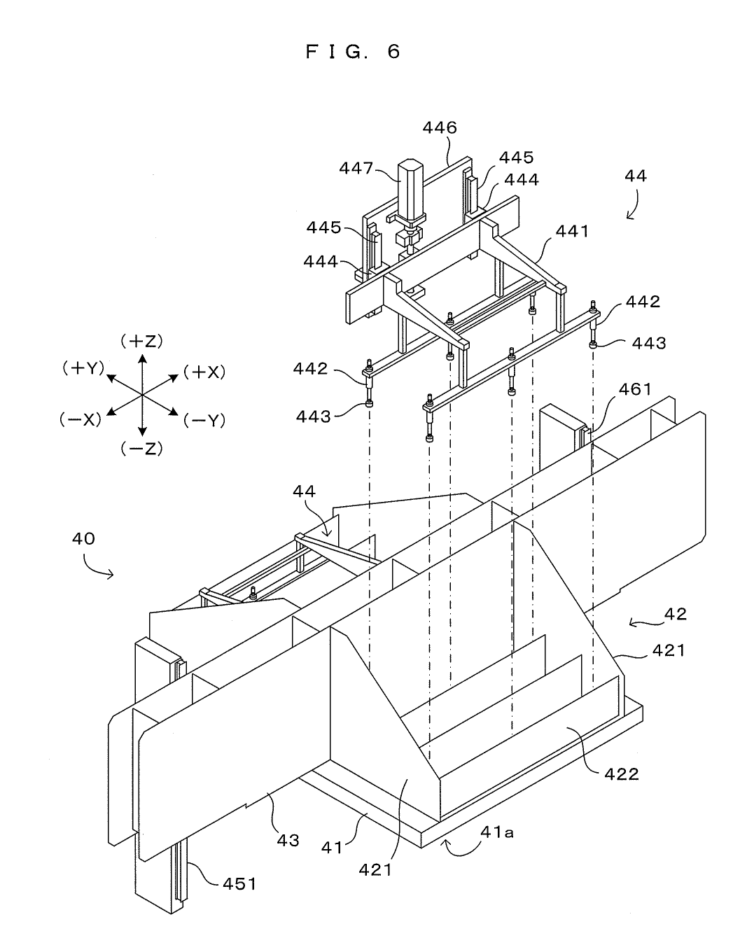

FIG. 6 is a view which shows the structure of the upper stage assembly. The upper stage assembly 40 includes an upper stage 41 for holding the plate PP or the substrate SB on the lower surface, a reinforcing frame 42 provided on the upper stage 41, a beam-like structure 43 bonded to the reinforcing frame 42 and horizontally extending in the X direction, and upper suction units 44 mounted on the upper stage 41. As shown in FIG. 6, the upper stage assembly 40 is substantially symmetrically shaped with respect to each of an XZ plane and a YZ plane including a center of the outer shape thereof.

The upper stage 41 is a flat plate-like member slightly smaller than the plane size of the plate PP or the substrate SB to be held and a lower surface 41a held in a horizontal posture serves as a holding flat surface for holding the plate PP or the substrate SB held in contact therewith. Since the holding flat surface is required to have high flatness, quartz glass or stainless steel plate is preferably used as a material. Further, the holding flat surface is provided with through holes used to mount suction pads of the upper suction units 44 to be described later.

The reinforcing frame 42 is composed of a combination of reinforcing ribs extending in the Z direction on the upper surface of the upper stage 41. As shown in FIG. 6, a plurality of reinforcing ribs 421 parallel to the YZ plane and reinforcing ribs 422 parallel to the XZ plane are appropriately combined to prevent the deflection of the upper stage 41 and maintain the flatness of the lower surface (holding flat surface) 41a thereof. The reinforcing ribs 421, 422 can be, for example, formed by metal plates.

Further, the beam-like structure 43 is a structure which is formed by combining a plurality of metal plates and whose longitudinal direction is the X direction, and vertically movable by being supported on the support columns 45, 46 on opposite end parts thereof. Specifically, guide rails 451, 461 extending in the Z direction are provided on the support columns 45, 46, whereas unillustrated sliders are attached to a (+Y) principal surface of the beam-like structure 43 facing the guide rails 451, 461. These are slidably engaged. As shown in FIG. 1, the beam-like structure 43 and the support column 46 are coupled by the elevation mechanism 47 and the beam-like structure 43 is moved in the vertical direction (Z direction) while maintaining a horizontal posture by the actuation of the elevation mechanism 47. Since the upper stage 41 is integrally coupled to the beam-like structure 43 via the reinforcing frames 42, the upper stage 41 is vertically moved with the holding flat surface 41a kept horizontal by the actuation of the elevation mechanism 47.

Note that the structures of the reinforcing frame 42 and the beam-like structure 43 are not limited to the shown ones. Although necessary strength is obtained by combining the plate-like members parallel to the YZ plane and the plate-like members parallel to the XZ plane here, plates, angle members and the like may be appropriately combined into a shape other than this. Such a structure is adopted to reduce the weight of the upper stage assembly 40. It is also considered to increase the thickness of the upper stage 41 and make the beam-like structure 43 solid to reduce the deflection of each component, but this will lead to an increase in the mass of the entire upper stage assembly 40.

If the weight of a structure arranged in an upper part of the apparatus is increased, a mechanism for supporting and moving this needs to have further strength and durability and the entire apparatus becomes very large and heavy. It is more realistic to reduce the weight of the entire structure while obtaining necessary strength by combining plate members and the like.

Further, the pair of upper suction units 44 are mounted in the upper part of the upper stage 41 surrounded by the reinforcing frame 42. A state where one upper suction unit 44 is taken out upward is shown in an upper part of FIG. 6. In the upper suction unit 44, suction pads 443 made of, for example, rubber are respectively attached to lower ends of a plurality of pipes 442 extending downward from the support frame 441. An upper end side of each pipe 442 is connected to the negative pressure supplier 704 of the control unit 7 via unillustrated pipe and control valve. The support frame 441 is shaped not to interfere with the ribs 421, 422 constituting the reinforcing frame 42.

The support frame 441 is supported movably in the vertical direction relative to the base plate 446 via a pair of sliders 444 and a pair of guide rails 445 engaged with the sliders 444. Further, the base plate 446 and the support frame 441 are coupled by an elevating mechanism 447 provided with an appropriate driving mechanism such as a motor and a ball screw mechanism. By the actuation of the elevating mechanism 447, the support frame 441 is elevated and lowered relative to the base plate 446, and the pipes 442 and the suction pads 443 are integrally elevated and lowered with this.

By fixing the base plates 446 to the both side surfaces of the beam-like structure 43, the upper suction units 44 are mounted on the upper stage 41. In this state, the lower end of each pipe 442 and the suction pad 443 are inserted into an unillustrated through hole provided on the upper stage 41. The suction pads 443 are elevated and lowered between a suction position where the lower surfaces thereof project further downward than the lower surface (holding flat surface 41a) of the upper stage 41 and a retracted position where the lower surfaces are retracted into the through holes of the upper stage 41 (upward) by the actuation of the elevating mechanism 447. Further, when the lower surfaces of the suction pads 443 are positioned substantially at the same height as the holding flat surface 41a of the upper stage 41, the upper stage 41 and the suction pads 443 can cooperate to hold the plate PP or the substrate SB on the holding flat surface 41a.

Referring back to FIG. 1, the upper stage assembly 40 configured as described above is provided on base plates 481. More specifically, the support columns 45, 46 respectively stand on the base plates 481 and the upper stage assembly 40 is attached to the support columns 45, 46 movably upward and downward. The base plates 481 are supported by upper stage block supporting mechanisms 482 mounted on the upper stage support frames 22, 23 and each provided with an appropriate movable mechanism such as a cross roller bearing.

Thus, the entire upper stage assembly 40 is horizontally movable relative to the main frame 2. Specifically, the base plates 481 horizontal move in a horizontal plane, i.e. an XY plane. A pair of base plates 481 provided to correspond to the respective support columns 45, 46 are movable independently of each other, and the upper stage assembly 40 is movable relative to the main frame 2 in predetermined ranges in the X, Y and θ directions as these base plates 481 move.

Each component of the pattern forming apparatus 1 configured as described above is controlled by the control unit 7. As shown in FIG. 2, the control unit 7 includes a CPU 701 for controlling the entire apparatus, a motor controller 702 for controlling motors provided in each component, a valve controller 703 for controlling control valves provided in each component and the negative pressure supplier 704 for generating a negative pressure to be supplied to each component. Note that the control unit 7 may include no negative pressure supplier if an externally supplied negative pressure is usable.

The motor controller 702 controls positioning and a movement of each component of the apparatus by controlling motors provided in each function block. Further, the valve controller 703 controls vacuum suction by the supply of the negative pressure and the release thereof and gas discharge from the hand upper surfaces 625a by controlling valves provided on a piping route of the negative pressure connected from the negative pressure supplier 704 to each function block and a piping route connected from the gas supplier 706 to each hand 625.

Further, this control unit 7 includes an image processor 705 for performing an image processing to images imaged by the cameras. The image processor 705 detects approximate positions of the substrate SB and the blanket BL by performing a predetermined image processing on images imaged by the pre-alignment cameras for substrate 241 to 243 and the pre-alignment cameras for blanket 244 to 246 attached to the main frame 2. Further, the image processor 705 accurately detects a positional relationship of the substrate SB and the blanket BL by performing a predetermined image processing on images imaged by alignment cameras for precise alignment 27 to be described later. The CPU 701 controls the upper stage block supporting mechanism 482 and the alignment supporting mechanism 605 based on these position detection results and aligns the positions of the plate PP or the substrate SB held by the upper stage 41 and the blanket BL held on the lower stage 61 (pre-alignment process and precise alignment process).

Next, a pattern forming process in the pattern forming apparatus 1 configured as described above is described. In this pattern forming process, the plate PP or the substrate SB held by the upper stage 41 and the blanket BL held on the lower stage 61 are proximately arranged to face each other across a tiny gap. Then, the transfer roller 641 moves along the lower surface of the blanket BL while locally pushing up the blanket BL by coming into contact with the lower surface of the blanket BL. The pushed-up blanket BL first locally comes into contact with the plate PP or the substrate SB and a contact part is gradually enlarged as the roller moves and, finally, the blanket BL is held in the entire plate PP or substrate SB. In this way, patterning from the plate PP to the blanket BL or pattern transfer from the blanket BL to the substrate SB is performed.

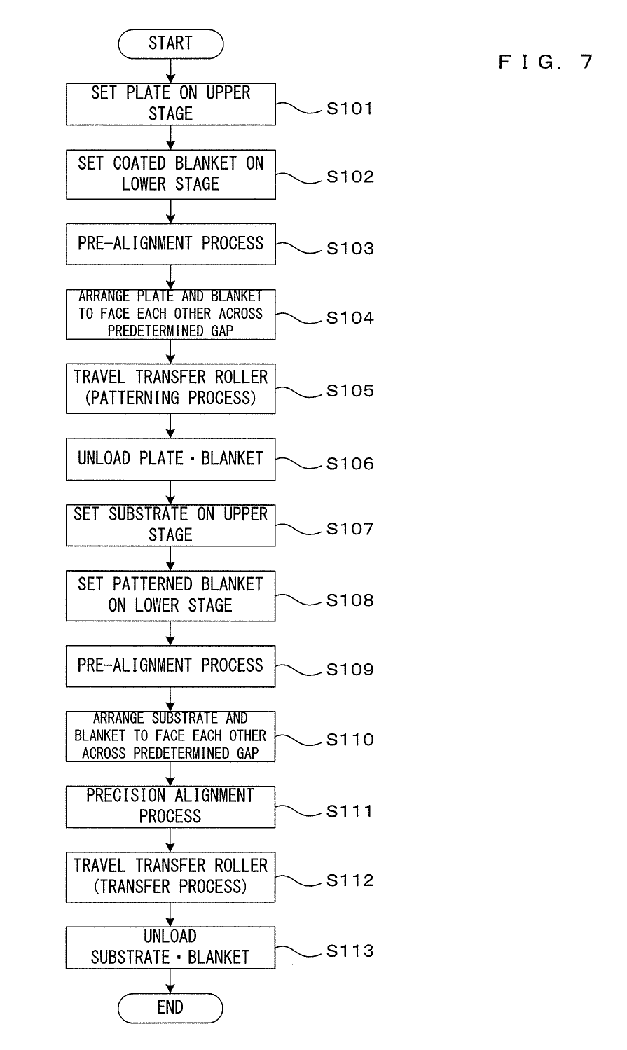

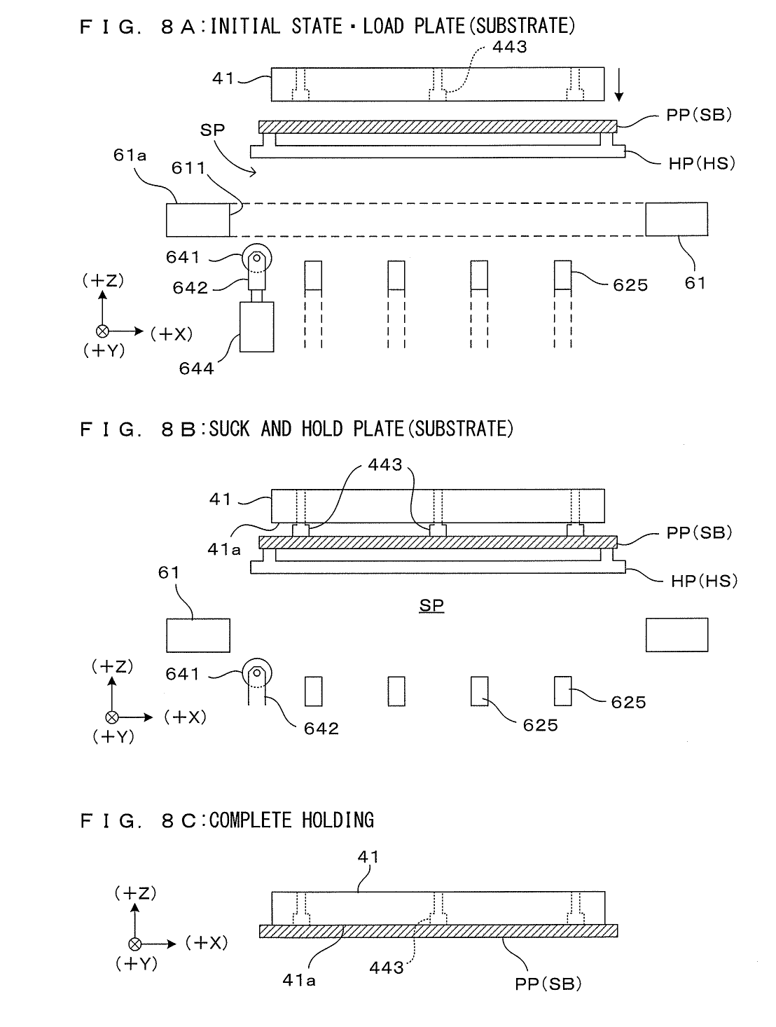

FIG. 7 is a flow chart which shows the pattern forming process. Further, FIGS. 8A to 15C are views which diagrammatically show a positional relationship of each component of the apparatus in each stage of the process. The operation of each component in the pattern forming process is described with reference to FIGS. 8A to 15C. Note that, to intelligibly show the relationship of each component in each stage of the process, components not directly related to the processing in each stage or reference signs to be attached thereto may not be shown. Further, since the operation when a processing object is the plate PP and the operation when the processing object is the substrate SB are identical except for some parts, the plate PP and the substrate SB are appropriately replaced using common figures.

In this pattern forming process, a plate PP corresponding to a pattern to be formed is first loaded into the initialized pattern forming apparatus 1 and set on the upper stage 41 (Step S101). Subsequently, a blanket BL formed with a uniform coating layer of a pattern forming material is loaded and set on the lower stage 61 (Step S 102). The plate PP is loaded with an effective surface corresponding to the pattern faced down and the blanket BL is loaded with the coating layer faced up.

FIGS. 8A to 8C show a process until the plate PP or the substrate SB is loaded into the apparatus and set on the upper stage 41. As shown in FIG. 8A, in an initial state, the upper stage 41 is retracted upward to increase a distance from the lower stage 61, and a wide processing space SP is formed between the both stages. Further, each hand 625 is retracted to a position below the upper surface of the lower stage 61. The transfer roller 641 is located at a position farthest in the (−X) direction and retracted downward from the upper surface of the lower stage 61 in the vertical direction (Z direction) out of positions facing the aperture window 611 of the lower stage 61. Each control valve connected to the negative pressure supplier 704 is closed.

In this state, the plate PP placed on an external hand for plate HP is loaded into the processing space SP from the front side of the apparatus, i.e. from a (−Y) side toward a (+Y) side after the thickness thereof is measured in advance. The hand for plate HP may be an operation tool which is manually operated by an operator or may be a hand of an external conveyor robot. At this time, a loading operation can be easily performed since the hands 625 and the transfer roller 641 are retracted downward. When the plate PP is positioned at a predetermined position, the upper stage 41 is lowered as shown by an arrow.

When the upper stage 41 is lowered to a predetermined position proximate to the plate PP, the suction pads 443 provided on the upper stage 41 protrude further downward than the lower surface of the upper stage 41, i.e. the holding flat surface 41a to come into contact with the upper surface of the plate PP as shown in FIG. 8B. By opening the control valves connected to the suction pads 443, the upper surface of the plate PP are sucked by the suction pads 443 and the plate PP is held. Then, by elevating the suction pads 443 with suction continued, the plate PP is lifted up from the hand for plate HP. At this point of time, the hand for plate HP moves to the outside of the apparatus.

Finally, as shown in FIG. 8C, the lower surfaces of the suction pads 443 are elevated to the same height as or slightly higher than the holding flat surface 41a, whereby the upper surface of the plate PP is held in close contact with the holding flat surface 41a of the upper stage 41. Suction grooves or suction holes may be provided on the lower surface of the upper stage 41 and the plate PP delivered from the suction pads 443 may be sucked by these. In this way, the holding of the plate PP is completed. A substrate SB can be loaded by a hand for substrate HS by a similar procedure.

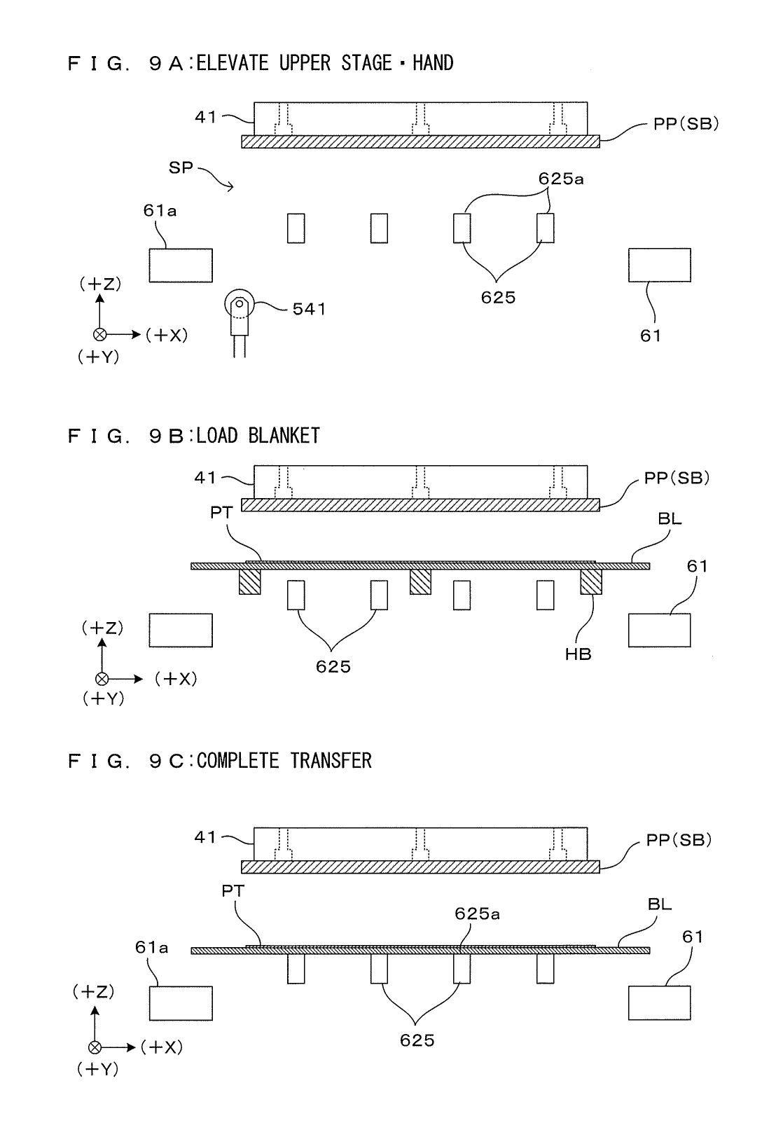

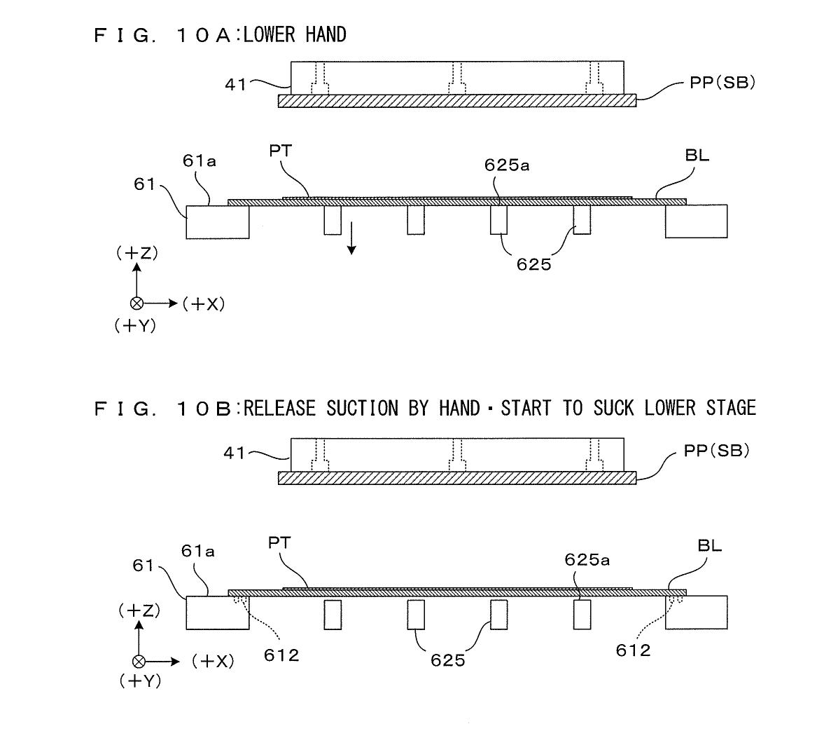

FIGS. 9A to 9C, 10A and 10B show a process until a blanket BL is loaded and held on the lower stage 61 after the plate PP is loaded. When the holding of the plate PP by the upper stage 41 is completed, the upper stage 41 is elevated to form the wide processing space SP again and each hand 625 is elevated to a position above the upper surface 61a of the lower stage 61 as shown in FIG. 9A. At this time, the upper surfaces 625a of the hands 625 are all at the same height.

In this state, as shown in FIG. 9B, the blanket BL formed with a coating layer PT of a pattern forming material on the upper surface is placed on an external hand for blanket HB and loaded into the processing space SP. The thickness of the blanket BL is measured before the blanket BL is loaded. The hand for blanket HB is desirably a fork type hand including fingers extending in the Y direction so as to be insertable through clearances between the hands 625 without interfering with the hands 625.

The hand for blanket HB is lowered after being inserted or the hands 625 are elevated, whereby the upper surfaces 625a of the hands 625 come into contact with the lower surface of the blanket BL and, thereafter, the blanket BL is supported by the hands 625 as shown in FIG. 9C. By supplying the negative pressure to the suction holes 625b (FIG. 4) provided on the hands 625, the blanket BL can be more reliably supported. In this way, the blanket BL can be transferred from the hand for blanket HB to the hands 625 and the hand for blanket HB can be discharged to the outside of the apparatus.

Thereafter, as shown in FIG. 10A, the hands 625 are lowered with the heights of the upper surfaces 625a of the hands 625 aligned and, finally, the hand upper surfaces 625a are set at the same height as the upper surface 61a of the lower stage 61. In this way, peripheral edge parts of four sides of the blanket BL come into contact with the upper surface 61a of the lower stage 61.

At this time, as shown in FIG. 10B, the blanket BL is sucked and held by supplying the negative pressure to the vacuum suction grooves 612 provided on the lower stage upper surface 61a. Associated with this, suction by the hands 625 is released. In this way, the blanket BL is set in a state where the peripheral edge parts of the four sides thereof are sucked and held by the lower stage 61. Although the blanket BL and the hands 625 are separated to explicitly show the release of suction holding by the hands 625 in FIG. 10B, a state where the lower surface of the blanket BL is in contact with the hand upper surface 625a is actually maintained.

If the hands 625 are separated in this state, the blanket BL is thought to have a downwardly convex shape as a whole because of a downward deflection of a central part thereof due to its own weight. By maintaining the hands 625 at the same height as the lower stage upper surface 61a, such a deflection can be suppressed and the blanket BL can be maintained in a planar state. In this way, the central part of the blanket BL is auxiliarily supported by the hands 625 while the peripheral edge part thereof is sucked and held by the lower stage 61, whereby the holding of the blanket BL is completed.

A loading order of the plate PP and the blanket BL may be reversed. However, in the case of loading the plate PP after the blanket BL is loaded, a foreign matter may drop onto the blanket BL to contaminate and cause a defect in the coating layer PT of the pattern forming material when the plate PP is loaded. By setting the blanket BL on the lower stage 61 after the plate PP is set on the lower stage 41 as described above, such a problem can be avoided.

Referring back to FIG. 7, when the plate PP and the blanket BL are respectively set on the upper and lower stages in this way, a pre-alignment process of the plate PP and the blanket BL is subsequently performed (Step S103). Further, a gap adjustment is performed so that the both face each other across a gap set in advance (Step S104).

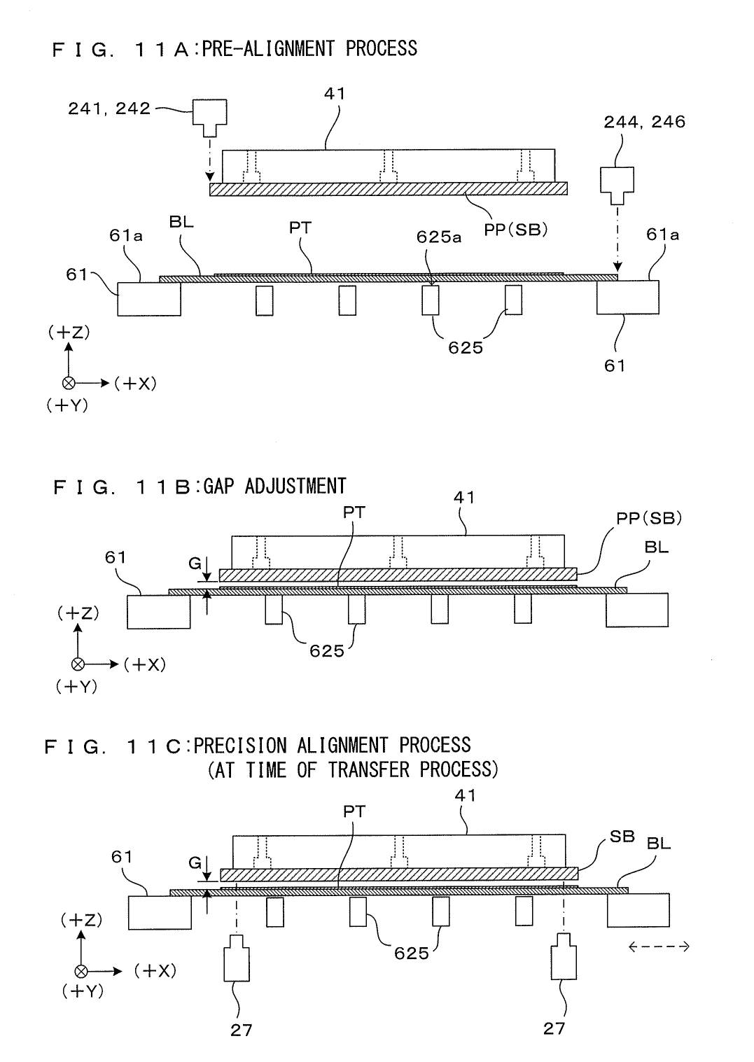

FIGS. 11A to 11C are views which show the course of a gap adjustment process and alignment processes. Out of these, a precise alignment process shown in FIG. 11C is described in the description of a transfer process to be made later since it is a process necessary only in the transfer process to be described later. The plate PP and the substrate SB or the blanket BL are loaded from the outside, but a displacement can occur when they are transferred. The pre-alignment process is a process for approximately positioning the plate PP or the substrate SB held by the upper stage 41 and the blanket BL held on the lower stage 61 at positions suitable for subsequent processes.

FIG. 11A is a side view diagrammatically showing the arrangement of a configuration for performing pre-alignment. As described above, a total of six pre-alignment cameras 241 to 246 are provided in the upper part of the apparatus in this embodiment. Out of these, three cameras 241 to 243 are pre-alignment cameras for substrate for detecting outer edges of the plate PP (or substrate SB) held by the upper stage 41. Further, the other three cameras 244 to 246 are pre-alignment cameras for blanket for detecting outer edges of the blanket BL. Note that although the pre-alignment cameras 241 to 243 are called “pre-alignment cameras for substrate” for the sake of convenience, these are usable both in positioning the plate PP and in positioning the substrate SB and the content of the process is also the same.

As shown in FIGS. 1 and 11A, the pre-alignment cameras for substrate 241, 242 are disposed at positions which are substantially the same positions in the X direction, but different from each other in the Y direction, and respectively image an (−X) side outer edge part of the plate PP or the substrate SB from above. Since the upper stage 41 is formed to have a smaller plane size than the substrate SB, the (−X) side outer edge part of the plate PP (or substrate SB) extending further outward than the end part of the upper stage 41 can be imaged from above. Further, although not shown, another pre-alignment camera for substrate 243 is provided on a front side with respect to the plane of FIG. 11A and this camera 243 images a (−Y) side outer edge part of the plate PP (or substrate SB) from above.

On the other hand, the pre-alignment cameras for blanket 244, 246 are disposed at positions which are substantially the same positions in the X direction, but different from each other in the Y direction, and respectively image an (+X) side outer edge part of the blanket BL placed on the lower stage 61 from above. Further, another pre-alignment camera for blanket 245 is provided on the front side with respect to the plane of FIG. 11A and this camera 245 images a (−Y) side outer edge part of the blanket BL from above.

The positions of the plate PP (or substrate SB) and the blanket BL are respectively grasped from an imaging result of these pre-alignment cameras 241 to 246. Then, by actuating the upper stage block supporting mechanism 482 and the alignment stage supporting mechanism 605 if necessary, the plate PP (or substrate SB) and the blanket BL are respectively positioned at target positions set in advance.

Note that when the blanket BL is horizontally moved together with the lower stage 61, the upper surface 625a of each hand 625 and the lower surface of the blanket BL are preferably separated as shown in FIG. 11A. For this purpose, the gas supplied from the gas supplier 706 can be discharged from the suction holes 625b of the hands 625. This holds true also for the precision alignment process to be described later.

Further, for a thin or large substrate SB which tends to be deflected, the substrate SB may be processed, for example, in a state where a plate-like supporting member is held in contact with the back surface of the substrate SB to facilitate handling. In such a case, even if the supporting member is larger than the substrate SB, a pre-alignment process similar to the above is possible if the positions of outer edge parts of the substrate SB are made easily detectable, for example, by forming the supporting member of a transparent material or providing transparent windows or through holes in parts of the supporting member.

Subsequently, as shown in FIG. 11B, the upper stage 41 holding the plate PP is lowered relative to the lower stage 61 holding the blanket BL to adjust a gap G between the plate PP and the blanket BL to a predetermined set value. At this time, the thicknesses of the plate PP and the blanket BL measured in advance are considered. Specifically, an interval between the upper stage 41 and the lower stage 61 is so adjusted that the gap between the plate PP and the blanket BL has a predetermined value after the thicknesses of the plate PP and the blanket BL are considered. The gap value G here can be, for example, set at about 300 μm.

The thicknesses of the plate PP and the blanket BL are desirably measured before each use due to conceivable individual differences caused by a dimensional variation in manufacturing and conceivable thickness changes caused by swelling even if components are identical. Further, the gap G may be defined to be a gap between the lower surface of the plate PP and the upper surface of the blanket BL or a gap between the lower surface of the plate PP and the upper surface of the coating layer PT of the pattern forming material carried on the blanket BL. This is technically equivalent as long as the thickness of the coating layer PT is strictly controlled in a coating stage.

Referring back to FIG. 7, when the plate PP and the blanket BL are arranged to face each other across the gap G in this way, the transfer roller 641 is subsequently caused to travel in the X direction while being held in contact with the lower surface of the blanket BL, thereby bringing the plate PP and the blanket BL into contact. In this way, the coating layer PT of the pattern forming material on the blanket BL is patterned by the plate PP (patterning process; Step S105).

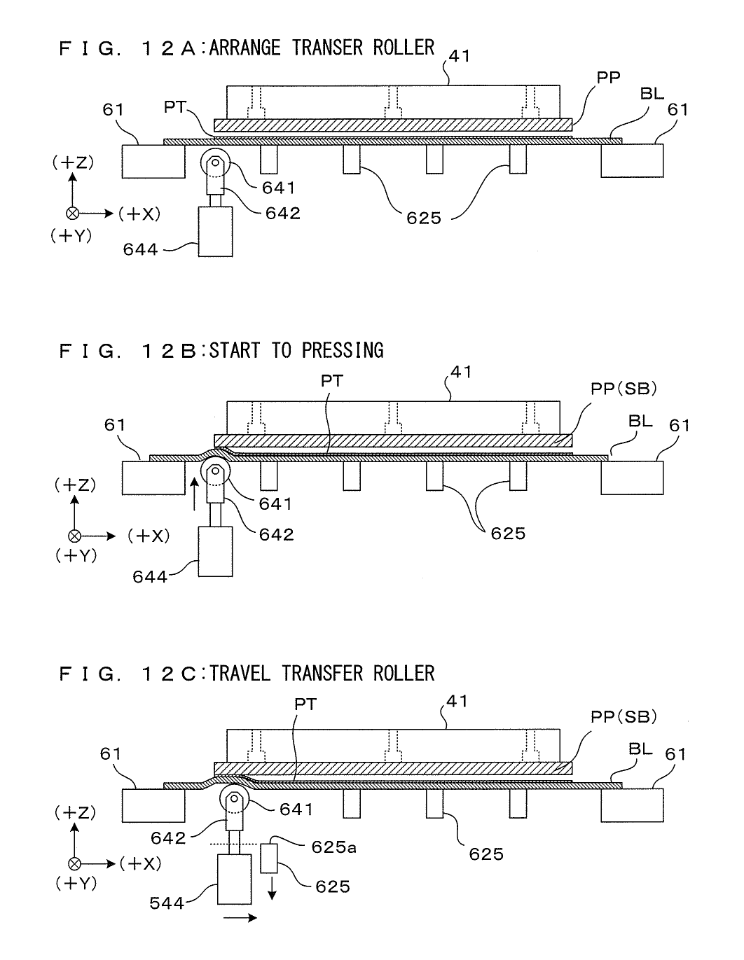

FIGS. 12A to 12C show the course of the patterning process. Specifically, as shown in FIG. 12A, the transfer roller 641 is elevated to a position directly below the blanket BL and arranged at such a position in the X direction that a center line of the transfer roller 641 substantially coincides with an end part of the plate PP or slightly shifted therefrom in the (−X) direction. In this state, as shown in FIG. 12B, the transfer roller 641 is further elevated to be brought into contact with the lower surface of the blanket BL and locally push up the blanket BL at this contact position. In this way, the blanket BL (strictly speaking, the coating layer PT of the pattern forming material carried on the blanket BL) is pressed against the lower surface of the plate PP with a predetermined pressing force. Since the transfer roller 641 is longer than the plate PP (and effective area) in the Y direction, a long and narrow region extending along the Y direction from one end to the other end of the lower surface of the plate PP in the Y direction comes into contact with the blanket BL.

By causing the elevating mechanism 644 to travel in the (+X) direction in a state where the transfer roller 641 keeps pressing the blanket BL in this way, the pushed-up position of the blanket BL is moved in the (+X) direction. To prevent the contact of the hands 625 with the transfer roller 641 at this time, the upper surface 625a of the hand 625 within a predetermined distance in the X direction from the transfer roller 641 is retracted downward at least to a position below the lower surface of the support frame 642 as shown in FIG. 12C.

Since suction by the hands 625 is already released, the blanket BL is not pulled downward as the hand 625 is lowered. Further, by appropriately controlling a timing, at which a lowering movement is started, in synchronization with the travel of the transfer roller 641, it can be prevented that the blanket BL having lost the support by the hand 625 hangs downward due to its own weight.

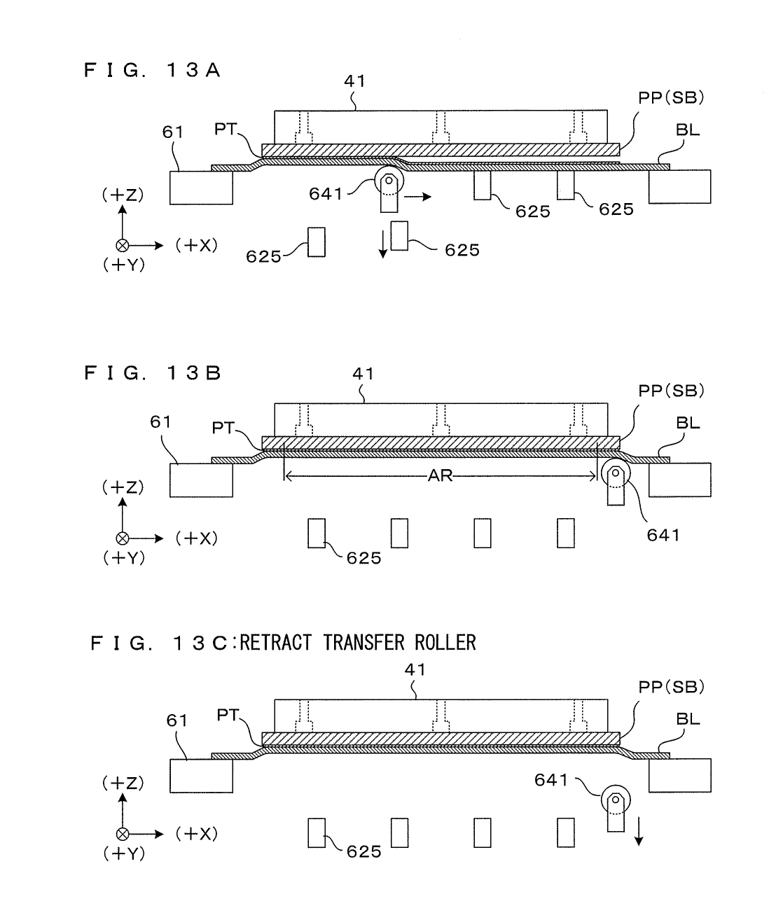

FIGS. 13A to 13C show a traveling course of the transfer roller 641. Since the plate PP and the blanket BL once held in contact are kept in a state held in close contact via the coating layer PT of the pattern forming material, a region where the plate PP and the blanket BL are in close contact is gradually enlarged in the (+X) direction as the transfer roller 641 travels as shown in FIG. 13A. At this time, as shown in FIG. 13A, the hands 625 are successively lowered as the transfer roller 641 approaches.

In this way, all the hands 625 are finally lowered and the transfer roller 641 reaches a near position to a (+X) side end part of the lower stage 61 as shown in FIG. 13B. At this point of time, the transfer roller 641 has reached a position substantially directly below the (+X) side end part of the plate PP or shifted slightly toward the (+X) side therefrom and the lower surface of the plate PP is entirely held in contact with the coating layer PT on the blanket BL.

While the transfer roller 641 travels at a maintained specified height, the area of the region of the lower surface of the blanket BL pressed by the transfer roller 641 is constant. Accordingly, the elevating mechanism 644 presses the transfer roller 641 against the blanket BL while giving a constant load, whereby the plate PP and the blanket BL are pressed against each other with a constant pressing force while sandwiching the coating layer PT of the pattern forming material therebetween. In this way, patterning from the plate PP to the blanket BL can be satisfactorily performed.

Note that, in patterning, it is ideal that the entire surface area of the plate PP can be effectively utilized, but there is unavoidably a region, which cannot be effectively utilized due to scratches, contact with the hand during conveyance or the like, on the peripheral edge part of the plate PP. As shown in FIG. 13B, if a central part of the plate PP excluding an end region is an effective area AR which effectively functions as a plate, the pressing force and traveling speed of the transfer roller 641 are desirably constant at least in the effective area AR. To this end, a length of the transfer roller 641 in the Y direction needs to be longer than that of the effective area AR in the same direction. Further, in the X direction, the transfer roller 641 desirably starts traveling at a position shifted toward (−X) side than an end part of the effective area AR in the (−X) direction and maintains a constant speed until reaching at least an end part of the effective area AR in the (+X) direction. A surface area of the blanket BL facing the effective area AR of the plate PP is an effective area of the blanket BL.

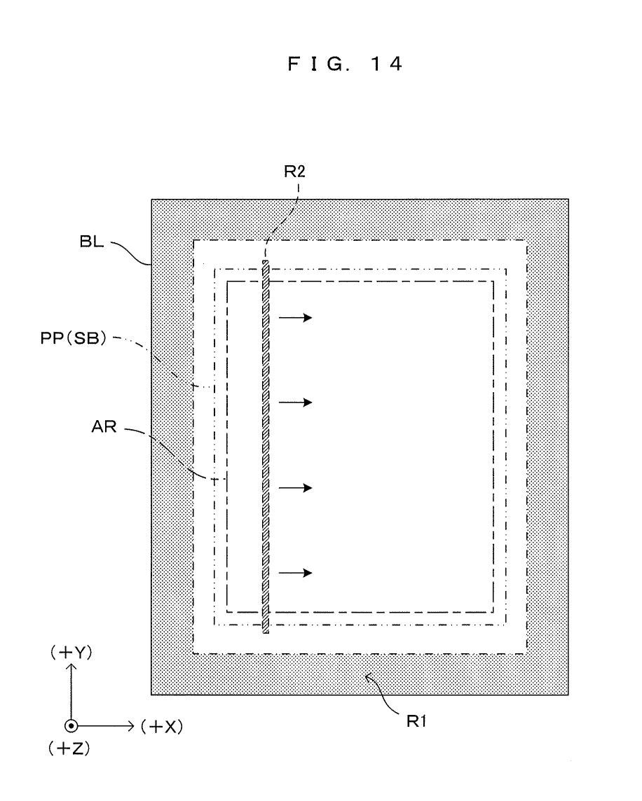

FIG. 14 is a view which shows a positional relationship of the plate or the substrate and the blanket. More specifically, FIG. 14 is a plan view showing a positional relationship when the plate PP or the substrate SB is in contact with the blanket BL when viewed from above. As shown in FIG. 14, the blanket BL has a larger plane size than the plate PP or the substrate SB. A region R1 of the blanket BL close to the peripheral edge part and shown by dots in FIG. 14 is a region to be held in contact with the lower stage upper surface 61a when the blanket BL is held on the lower stage 61. This causes the blanket BL to be held on the lower stage 61 in a state where the lower surface of an inner region is open.

The plate PP and the substrate SB have substantially the same size and are smaller than an aperture window size of the lower stage 61. Further, the effective area AR effectively used in actual pattern formation is smaller than the size of the plate PP or the substrate SB. Thus, a region of the blanket BL corresponding to the effective area AR is in a state where the lower surface is open and facing the aperture window 611 of the lower stage 61.

A hatched region R2 shows a region (pressing region) of the lower surface of the blanket BL to be simultaneously pressed by the transfer roller 641. The pressing region R2 is a long and narrow region extending in a roller extending direction, i.e. in the Y direction and opposite end parts thereof in the Y direction respectively extend further outward than the end parts of the plate PP or the substrate SB. Thus, when the transfer roller 641 presses the blanket BL in a state parallel to the lower surface of the blanket BL, a pressing force thereof is uniform in the Y direction from one end part to the other end part of the effective area AR in the Y direction.

By moving the transfer roller 641 in the X direction while giving a uniform pressing force to the effective area AR in the Y direction in this way, the plate PP or the substrate SB and the blanket BL are pressed against each other with the uniform pressing force in the entire effective area AR. This enables the formation of a pattern of good quality by preventing damage of the pattern due to uneven pressing.

When the transfer roller 641 reaches the (+X) side end part in this way, the travel of the transfer roller 641 is stopped and the transfer roller 641 is retracted downward as shown in FIG. 13C. This causes the transfer roller 641 to be separated from the lower surface of the blanket BL, thereby finishing the patterning process.

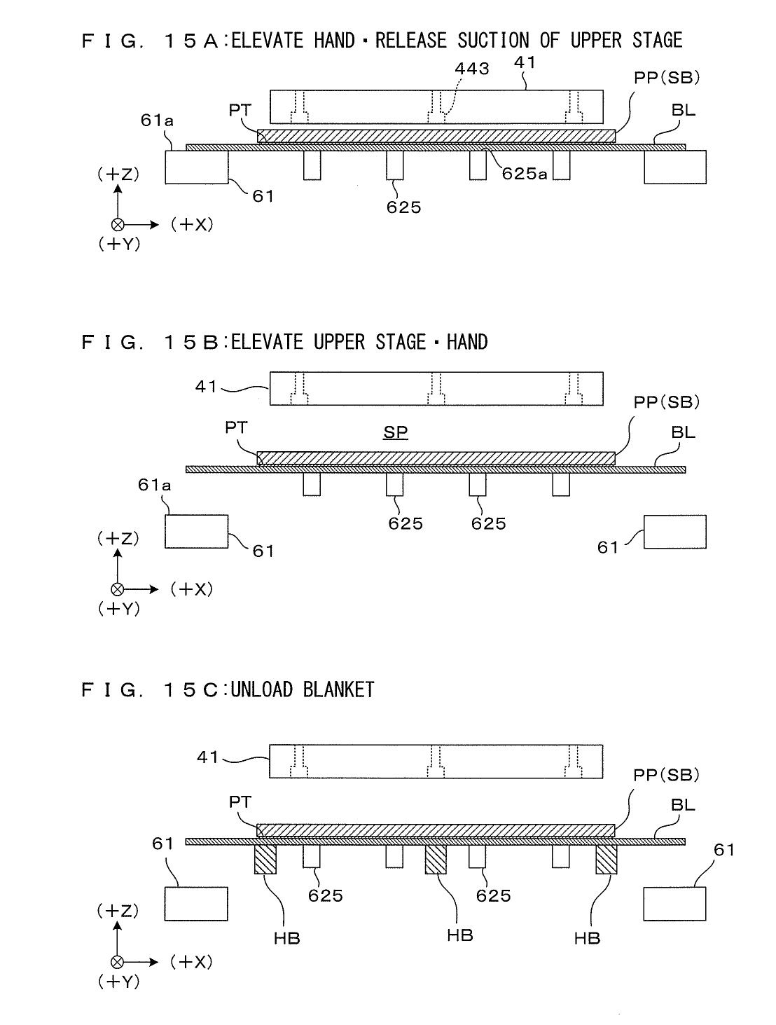

Referring back to FIG. 7, when the patterning process is finished in this way, the plate PP and the blanket BL are unloaded (Step S106). FIGS. 15A to 15C show a process of unloading the plate and the blanket. First, as shown in FIG. 15A, each hand 625 lowered during the patterning process is elevated again and positioned at a position where the upper surface 625a is at the same height as the upper surface 61a of the lower stage 61. In this state, the suction of the plate PP by the suction pads 443 (if the plate PP is sucked by suction grooves or suction holes, the suction thereof) of the upper stage 41 is released. This causes the holding of the plate PP by the upper stage 41 to be released, whereby a laminate formed by uniting the plate PP and the blanket BL via the coating layer PT of the pattern forming material remains on the lower stage 61. A central part of the laminate is supported by the hands 625.

Subsequently, as shown in FIG. 15B, the upper stage 41 is elevated to form the wide processing space SP, suction by the grooves 612 of the lower stage 61 is released and the hands 625 are elevated further upward than the lower stage 61. At this time, the laminate is preferably sucked and held by the hands 625.

By doing so, an external access is possible. Accordingly, as shown in FIG. 15C, the hand for blanket HB is allowed to enter from the outside and the blanket BL held in close contact with the plate PP is unloaded to the outside by operations opposite to those at the time of loading. If the plate PP held in close contact in this way is detached from the blanket BL by an appropriate detacher, a predetermined pattern is formed on the blanket BL.

Next, a case of transferring the pattern formed on the blanket BL to the substrate SB, which is a final target, is described. This process is basically the same as in the case of the patterning process. Specifically, the substrate SB is set on the upper stage 41 (Step S107) and the blanket BL already formed with the pattern is set on the lower stage 61 (Step S108) as shown in FIG. 7. Then, by causing the transfer roller 641 to travel below the blanket BL after the pre-alignment process and the gap adjustment are performed for the substrate SB and the blanket BL (Steps S109, S110), the pattern on the blanket BL is transferred to the substrate SB (transfer process; Step S112). After the transfer is finished, the united blanket BL and the substrate SB are unloaded to finish the process (Step S113). These series of operations are also the same as those shown in FIGS. 8A to 15C. Note that the reference PT denotes the pattern after the patterning process in these figures when the plate PP and the substrate SB are replaced.

In the transfer process, to properly transfer the pattern to a predetermined position of the substrate SB, the positions of the substrate SB and the blanket BL are more precisely aligned (precise alignment process) before the substrate SB and the blanket BL are brought into contact (Step S111). FIG. 11C shows that process.

Although not shown in FIG. 1, this pattern forming apparatus 1 includes the precise alignment cameras 27 supported on the support columns erected in the (+Z) direction from the base frame 21. A total of four precise alignment cameras 27 are provided with optical axes thereof facing vertically upward so as to image four corners of the substrate SB through the aperture window 611 of the lower stage 61.

Alignment marks (substrate-side alignment marks) as position references are formed in advance on the four corners of the substrate SB, whereas blanket-side alignment marks are formed as parts of the pattern to be patterned by the plate PP at positions of the blanket BL corresponding to the substrate-side alignment marks. One of the substrate-side alignment marks and the corresponding blanket-side alignment mark are imaged within the same visual fields by the precise alignment cameras 27, a displacement amount of the substrate SB and the blanket BL is obtained by detecting a positional relationship of the alignment marks and a movement amount of the blanket BL to correct such a displacement is calculated. By moving the alignment stage 601 by the obtained movement amount by the alignment stage supporting mechanism 605, the lower stage 61 moves within a horizontal plane and the displacement between the substrate SB and the blanket BL is corrected.

By imaging the alignment marks formed on the substrate SB and the blanket BL by the same cameras with the substrate SB and the blanket BL arranged to face across the tiny gap G, the positions of the substrate SB and the blanket BL can be aligned with high accuracy. In this sense, the above alignment process can be called a precise alignment process more accurate than the one in the case of individually imaging the substrate SB and the blanket BL and aligning the positions thereof. By bringing the both into contact in that state, the pattern aligned with the predetermined position of the substrate SB with high accuracy can be formed in this embodiment. By performing the pre-alignment process of the substrate SB and the blanket BL in advance, the alignment marks formed on the substrate SB and the blanket BL can be positioned within the visual fields of the precise alignment cameras 27.

Note that such a precise alignment process is not always necessary in forming a pattern on a blanket BL by a plate PP. This is because, by forming the blanket-side alignment marks together with the pattern on the plate PP in advance, the pattern formed on the blanket BL and the blanket-side alignment marks are not displaced and a slight displacement of the plate PP and the blanket BL does not affect pattern formation as long as the blanket-side alignment marks and the substrate-side alignment marks are precisely aligned. In this respect, only the pre-alignment process is performed in the patterning process.

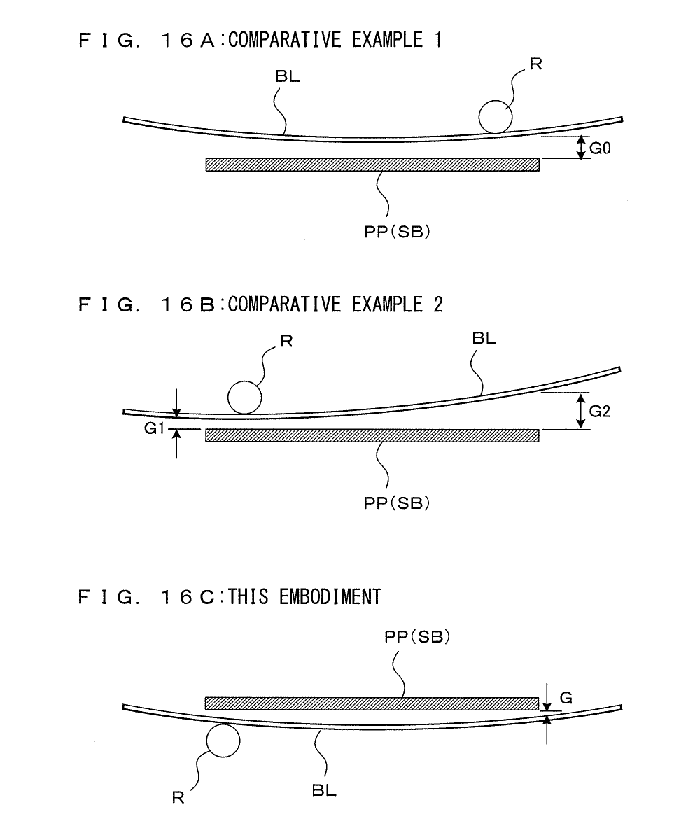

Further, such precise position alignment is possible because this pattern forming apparatus 1 is so configured that the transfer roller 641 is brought into contact with the blanket BL from below. This point is described with reference to FIGS. 16A to 16C. Note that although a combination of the substrate SB and the blanket BL is described below in view of the importance of position alignment, the same holds true for a combination of the plate PP and the blanket BL.

FIGS. 16A to 16C are views which show the superiority of the configuration for pressing the blanket from below. In a comparative example 1 shown in FIG. 16A, a blanket BL is arranged at an upper side and a plate PP or a substrate SB is arranged at a lower side and the blanket BL is pressed by a roller R from above the blanket BL. Since the blanket BL can be, in principle, held only on a peripheral edge part in such a configuration, it is unavoidable that the blanket BL is deflected due to its own weight and a central part hangs down relative to the peripheral edge part as shown in FIG. 16A. Particularly, in recent years, this tendency has been notable since substrates have become larger in size and blankets corresponding thereto also need to be enlarged. Further, it is difficult to control the amount of this deflection.

Accordingly, to avoid unintended contact of the substrate SB and the blanket BL before pressing, the gap G0 between the substrate SB and the blanket BL in a state facing each other before pressing has to be large to a certain extent. Then, the positions of the substrate SB and the blanket BL at a long distance from each other have to be aligned and precise position alignment is difficult. Further, a movement amount until the substrate SB and the blanket BL are brought toward and into contact with each other becomes larger, thereby causing a problem that a displacement during this movement becomes larger.

Further, in a comparative example 2 shown in FIG. 16B, it is attempted to avoid unintended contact by performing a transfer in a state where one end of the blanket BL is arranged proximately to the substrate SB and the other end is arranged at a distance as in the technique disclosed in the aforementioned patent literature (JP2002-036499A). In this case, even though highly accurate position alignment is possible at one end side with a small gap G1, position alignment at the other end side with a large gap G2 is not possible. Further, since a movement amount is large at the other end side, a displacement may gradually increase as the transfer progresses.

Contrary to theses, since the roller R is brought into contact with the blanket BL arranged at the lower side from below in this embodiment shown in FIG. 16C, even if the central part of the blanket BL hangs down, it hangs down in a direction away from the substrate SB and unintended contact does not occur. Thus, tiny gaps G can be set at opposite end sides in a roller traveling direction, whereby highly accurate position alignment is possible and the displacement after the position alignment can be suppressed to be small due to a small movement amount during the transfer.

Further, since no roller is arranged above the substrate SB at the upper side, there is no restriction on the holding of the upper surface side and the substrate SB can be so held as not be deflected. Further, also for the blanket BL, the lower surface of the blanket BL can be auxiliarily supported within a range not to hinder the travel of the roller such as by the hands 625 of this embodiment and the deflection can be reduced more.

As described above, in this embodiment, the lower stage 61 functions as a “first holder” and a “holding frame” of the present invention, and the upper stage 41 functions as a “second holder” and a “plate-like member” of the present invention. Further, the transfer roller 641 functions as a “push-up roller” of the present invention, whereas the elevating mechanism 644 functions as a “mover” of the present invention. These integrally function as a “push-up unit” of the present invention. Further, in this embodiment, the hands 625 function as an “auxiliary holder” of the present invention. Furthermore, in this embodiment, the plate PP and the substrate SB correspond to a “processing object” of the present invention.

### Second Embodiment

Next, a second embodiment of the pattern forming apparatus according to this invention is described. In the pattern forming apparatus of the second embodiment, the structure of a lower stage block partly differs from that of the pattern forming apparatus 1 of the first embodiment described above. On the other hand, other components in the first embodiment, i.e. the main frame 2, the upper stage block 4, the control unit 7 and the like can be basically applied as a main frame, an upper stage block, a control unit and the like in the second embodiment as they are. Accordingly, the following description is centered on points of difference from the first embodiment, particularly the structure and operation of the lower stage block. Further, the same components as in the first embodiment are denoted by the same reference signs and not described.

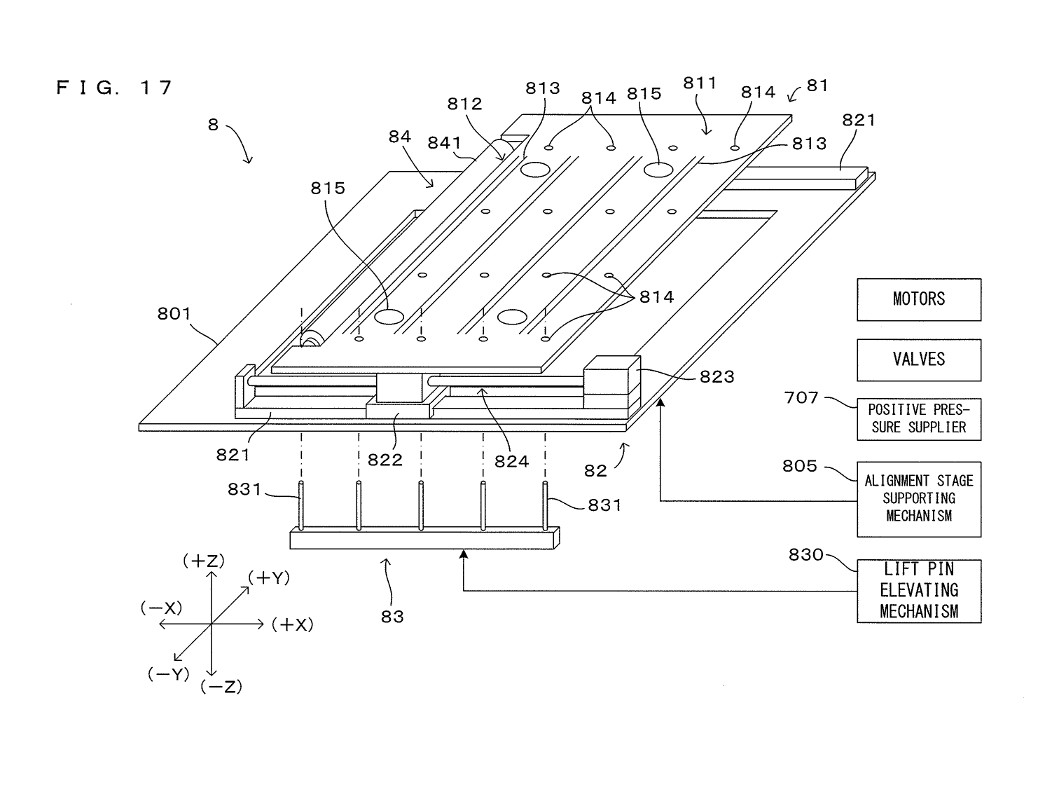

FIG. 17 is a view which shows a main part of the second embodiment of the pattern forming apparatus according to this invention. More specifically, FIG. 17 is a view showing the structure of a lower stage block 8 in the second embodiment. The lower stage block 8 includes an alignment stage 801. This alignment stage 801 corresponds to the alignment stage 601 in the first embodiment and the structure and functions thereof are also substantially the same. Specifically, the alignment stage 801 has a plate shape with an open central part and is supported movably relative to a base frame 21 (FIG. 1) within a predetermined range by an alignment stage supporting mechanism 805 having functions equivalent to those of the alignment stage supporting mechanism 605 of the first embodiment.

A lower stage 81 is arranged above the alignment stage 801. Specifically, a lower stage supporting mechanism 82 is mounted on the upper surface of the alignment stage 801 and the lower stage 81 is supported by the lower stage supporting mechanism 82. The lower stage 81 is a plate-like member supported substantially in a horizontal posture and the upper surface thereof is finished to be substantially flat and serves as a contact surface 811 to be held in contact with the lower surface of a blanket BL. By placing the blanket BL on the contact surface 811, the lower stage 81 supports the blanket BL.

The lower stage 81 has a substantially rectangular outer shape. A cut 812 into which a transfer roller 841 to be described later is to be inserted is provided on one side out of four sides of the rectangular shape. As described later, it is not an essential requirement to provide such a cut.

Further, a plurality of grooves 813 are engraved on the contact surface 811 of the upper surface of the lower stage 81. Note that the number and arrangement of the grooves are arbitrary without being limited to the shown ones. A negative pressure supplied from a negative pressure supplier 704 (FIG. 2) of a control unit 7 and a positive pressure supplied from a positive pressure supplier 707 newly provided in the control unit 7 in this embodiment are selectively supplied to each groove 813 via an unillustrated pipe. In a state where the negative pressure is supplied to the grooves 813, the lower stage 81 can suck and hold the blanket BL placed on the upper surface.

On the other hand, in a state where the positive pressure is supplied to the grooves 813, a thin air layer is formed between the lower stage 81 and the blanket BL and the blanket BL is held in a state floated from the contact surface 811 of the upper surface of the lower stage 81. The reason for this arrangement is described later.

A plurality of through holes 814 penetrating from an upper surface (contact surface) 811 to a lower surface are distributed and arranged in the stage 81. A lift pin 831 is inserted into each through hole 814. More specifically, a lifter unit 83 is arranged to face an aperture in the center of the alignment stage 801 and a plurality of lift pins 831 provided in the lifter unit 83 are respectively inserted into the through holes 814. Note that although only a part of the lifter unit 83 is shown in FIG. 17, the lifter unit 83 includes the lift pins 83 corresponding to the respective through holes 814 provided in the stage 81.

The lifter unit 83 is supported movably upward and downward by a lift pin elevating mechanism 830. In a state where the lift pin elevating mechanism 830 elevates and positions the lifter unit 83 at an upper position, the upper end of each lift pin 831 projects upward from the upper surface (contact surface) 811 of the lower stage 81 from the through hole 814. In this state, the lifter unit 83 can support the blanket BL in a state separated from the lower stage 81. Accordingly, it is possible to receive an unprocessed blanket BL being loaded into the apparatus by being held by an external robot hand or the like and transfer the processed blanket BL to the robot hand or the like.

On the other hand, in a state where the lift pin elevating mechanism 830 lowers the lifter unit 83, the upper end of each lift pin 831 is located below the upper surface (contact surface) 811 of the lower stage 81. In this state, the contact surface 811 of the lower stage 81 supports the blanket BL. In this way, by elevating and lowering the lifter unit 83, the blanket BL can be transferred between the lower stage block 8 and an external apparatus.

Further, transparent windows 815 formed of, for example, quartz glass are provided at four positions of the stage 81 and it is possible to view an upper side of the lower stage 81 from a lower side via these transparent windows 815. Although not shown, four precise alignment cameras 27 (FIG. 2) are provided also in this embodiment as in the first embodiment, one precise alignment camera 27 is fixed to a base frame 21 (more strictly, support column erected on the base frame 21) below each of the four transparent windows 815 with an imaging direction set at a vertical upward direction. Thus, the four precise alignment cameras 27 can image alignment marks (blanket-side alignment marks formed on the upper surface of the blanket BL and substrate-side alignment marks formed on the substrate SB) through the aperture of the alignment stage 81, the transparent windows 815 of the lower stage 81 and the blanket BL placed on the lower stage 81.

The thus configured upper stage 81 is mounted on the alignment stage 801 via the lower stage supporting mechanism 82. The lower stage supporting mechanism 82 includes a pair of guide rails 821, 821 extending in the X direction on opposite end parts of the alignment stage 801 in the Y direction, i.e. on a (+Y) side end part and a (−Y) side end part, and the lower stage 81 is fixed to a slider 822 slidably attached to the guide rail 821. A motor 823 is provided near one end part of the guide rail 821 located on the (−Y) side. A ball screw mechanism 824 extending in the X direction is coupled to a rotary shaft of the motor 823. A ball nut constituting the ball screw mechanism 824 is united with the slider 822. Thus, when the motor 823 rotates in response to a control command from the control unit 7, a rotational motion thereof is translated into a linear motion by the ball screw mechanism 824 and the lower stage 81 is moved in the X direction together with the slider 822.

A transfer roller unit 84 is provided at a (−X) side of and adjacent to the lower stage 81. A specific configuration of this transfer roller unit 84 is similar to that of the transfer roller unit 64 of the first embodiment. Specifically, the transfer roller unit 84 includes a transfer roller 841 whose axial direction is the Y direction and which is rotatably supported, and the transfer roller 841 is configured to be movable toward and away from the lower surface of the blanket BL by moving in the vertical direction (Z direction) and movable in contact with the lower surface of the blanket BL in the X direction. Specifically, in this embodiment, a moving direction of the transfer roller 841 and that of the lower stage 81 are the same.

Besides, the lower stage block 8 of this embodiment includes valves for controlling the supply and the stop of the positive pressure and the negative pressure to the grooves 814 and motors for mechanically driving the respective components similarly to the lower stage block 6 of the first embodiment, and these are controlled by the control unit 7.

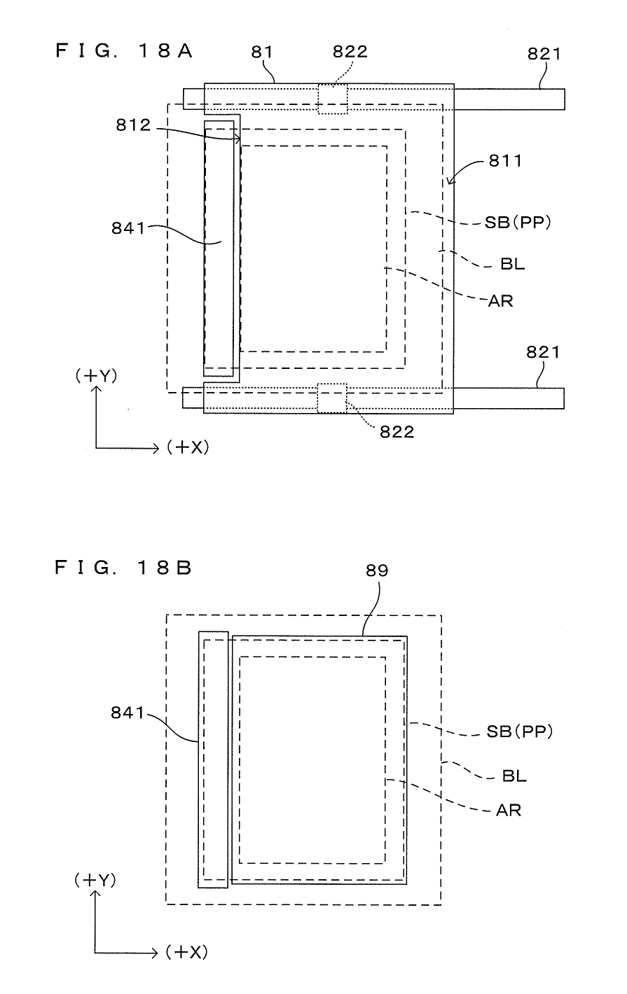

FIGS. 18A and 18B are views which show positional relationships of the lower stage, the substrate and the blanket. More specifically, FIG. 18A shows a positional relationship in a horizontal direction of the lower stage 81, the blanket BL placed on the lower stage 81 and the substrate SB (or plate PP) arranged to face the blanket BL in the second embodiment.

As shown in FIG. 18A, the contact surface 811 of the lower stage 81 has a larger plane size than an effective area AR of the blanket BL where a pattern is carried. Although it is necessary to support the entire effective area AR by the contact surface 811 in this way, a supporting mode of the blanket BL outside the effective area AR is arbitrary as long as a downward deflection of the peripheral edge part of the blanket BL due to gravity can be suppressed. In this embodiment, the lower stage 81 is longer than the blanket BL in the Y direction. Thus, the deflection of the opposite end parts of the blanket BL in the Y direction due to gravity is avoided. Further, the contact surface 811 of the lower stage 81 extends further outward than a (+X) side end part of the blanket BL, i.e. toward the (+X) side.

On the other hand, a (−X) side end part of the blanket BL is held in a state protruding further outward than the end part of the lower stage 81, i.e. toward the (−X) side. More specifically, a (−X) side end part of the effective area AR of the blanket BL is located inside the contact surface 811, but the (−X) end part of the blanket BL itself protrudes toward the (−X) side from the contact surface 811 and is not supported by the contact surface 811. Note that it is not necessary that the (−X) end part of the blanket BL is not supported. Such a configuration is adopted to ensure a space for arranging the transfer roller 841.

When being positioned at a predetermined initial position, the transfer roller 841 is arranged adjacent to a (−X) side end part of the lower stage 81 to be located inside the cut 812 of the lower stage 81. Thus, the lower stage 81 extends in the (−X) direction at outer sides of the opposite end parts of the transfer roller 841 in the Y direction, and the blanket BL is supported on these parts. This prevents the blanket BL from being deflected downward, i.e. toward the transfer roller 841 due to gravity.

As in the first embodiment, the substrate SB (or plate PP) held to face the blanket BL by the upper stage 41 (FIG. 6) is positioned in such a state where a (−X) side end part thereof slightly protrudes out from the cut 812 provided near the (−X) side end part of the lower stage 81. Thus, outside the effective area AR, the transfer roller 841 is located at a position directly below the (−X) side end part of the substrate SB (or plate PP). Note that, as in the first embodiment, the transfer roller 841 is longer than the substrate SB (or plate PP) in the Y direction.

FIG. 18B shows a minimum size of a lower stage. A lower stage 89 shown in FIG. 18B has a minimum necessary plane size to effectively hold the blanket BL. The lower stage needs to be larger than at least the plane size of the effective area AR of the blanket BL in this way, but needs not be larger than the substrate SB (or plate PP) and the blanket BL. Further, a structure including no cut into which the transfer roller 841 is to be inserted may be adopted. Particularly, when the size of a margin part outside the effective area AR is relatively small in the blanket BL, the lower stage may not extend up to the margin part in some cases since the blanket BL is thought to be deflected to a small extent due to an unsupported peripheral edge part.

In short, the shape and size of the lower stage can be appropriately determined without being limited to the above embodiments as long as the transfer roller 841 can be arranged directly below the substrate SB (or plate PP) at the outer side of the effective area AR and the blanket BL can be supported in a horizontal posture without being deflected.

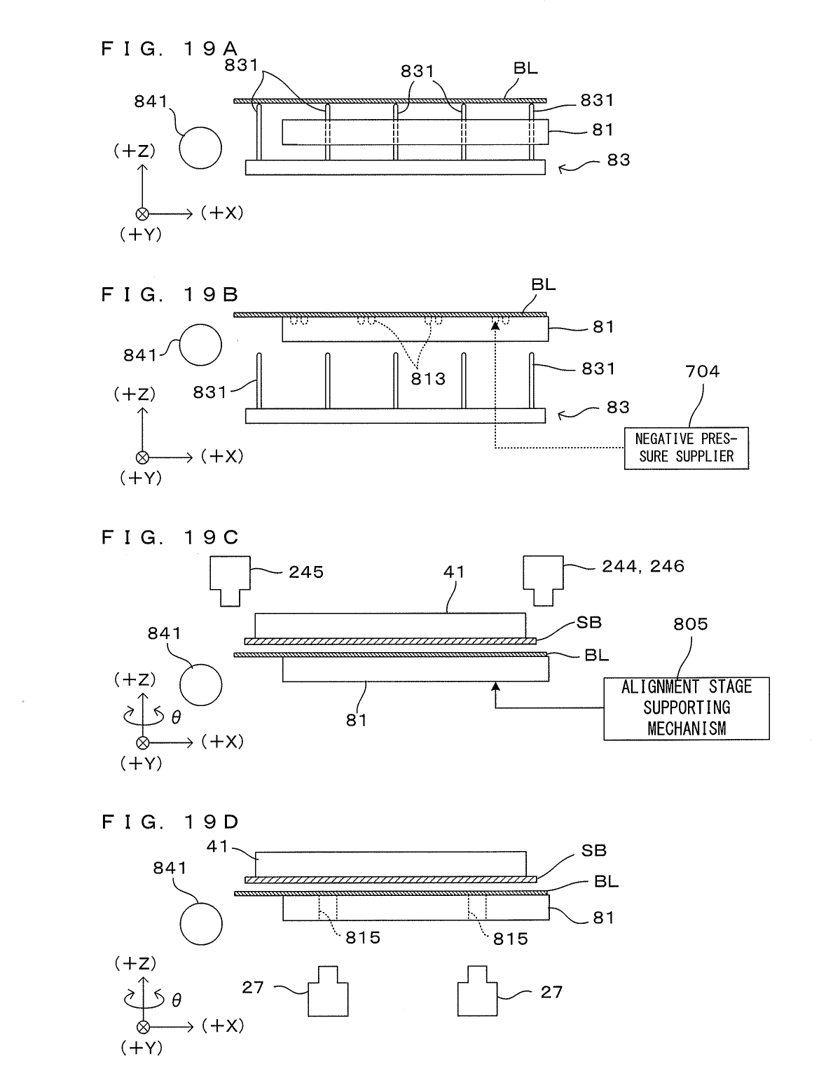

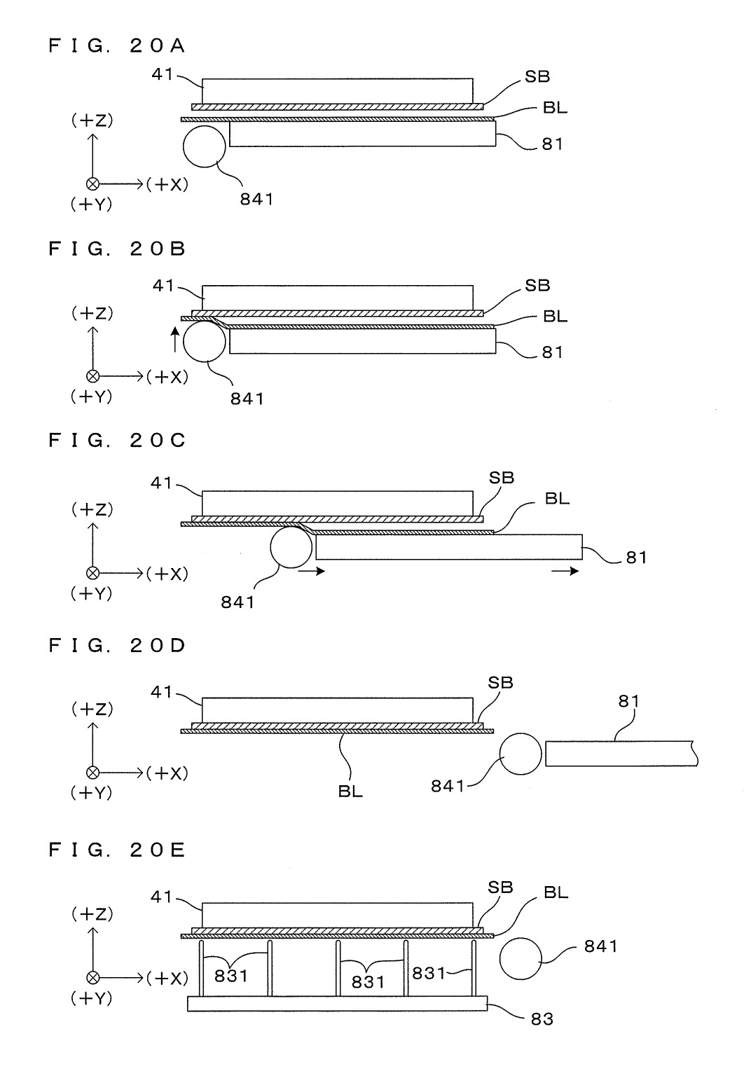

Next, the pattern forming process by the pattern forming apparatus of this embodiment are described. The purpose and basic operation of this process are similar to those of the process (FIG. 7) in the above first embodiment. However, the operation of each component constituting the lower stage block differs from that in the first embodiment due to a difference in the structure of the lower stage block. Specifically, a process of loading the substrate SB or the plate PP into the apparatus and holding it by the upper stage 41 is the same as in the first embodiment. On the other hand, a process until the blanket BL is loaded into the apparatus and brought into close contact with the substrate SB or the plate PP held by the upper stage 41 is different from that of the first embodiment. The following description is given centering on the process different from the first embodiment with reference to FIGS. 19A to 19D and 20A to 20E.

FIGS. 19A to 19D and 20A to 20E are views which diagrammatically show a positional relationship of each component of the apparatus in each stage of the pattern forming process of the second embodiment. Note that the operation of each component is described here when a substrate SB is held by the upper stage 41, a blanket BL already formed with a pattern is loaded onto the lower stage 81 and a transfer process (Steps S107 to S112 of FIG. 7) is performed. However, as described in the first embodiment, an operation of performing a patterning process using the plate PP and the blanket BL (Step S101 to S105 of FIG. 7) is basically the same as the transfer process except that a precise alignment process is not performed. Thus, in the following description, an operation in the patterning process is also described by replacing the “substrate SB” by the “plate PP” and omitting the precise alignment process.

As shown in FIG. 19A, when the blanket BL is loaded from the outside, the lifter unit 83 is positioned at the upper position, whereby each lift pin 831 projects upward from the upper surface 811 of the lower stage 81. Accordingly, the blanket BL can be received from a hand for blanket (not shown) of an external conveyor robot or the like. Note that, at this time, the transfer roller 841 is positioned at a retracted position retracted further toward the (−X) side than the initial position shown in FIG. 18A to avoid interference with the elevating and lowering lift pins 831.

By lowering the lifter unit 83 and retracting the lift pins 831 downward from the contact surface 811 of the lower stage 81 in this state, the blanket BL is transferred from the lifter unit 83 to the lower stage 81 as shown in FIG. 19B. When the blanket BL is placed on the upper surface (contact surface) 811 of the lower stage 81, the negative pressure from the negative pressure supplier 704 is supplied to the grooves 814 provided on the contact surface 811, whereby the blanket BL is sucked and held onto the contact surface 811. That is, the grooves 814 function as vacuum suction grooves at this time.

Subsequently, the gap adjustment and the pre-alignment process are performed. In the pre-alignment process, a peripheral edge part of the blanket BL is imaged by the pre-alignment cameras for blanket 244 to 246 and the blanket BL is moved in a horizontal plane according to an imaging result, thereby being positioned at a target position, similarly to the same process in the first embodiment. At this time, as shown in FIG. 19C, the alignment stage supporting mechanism 805 moves the lower stage 81 in the X, Y and θ directions together with the alignment stage 801 to position the blanket BL.

Subsequently, the precise alignment process is performed. As shown in FIG. 19D, the blanket BL and the substrate SB held by the upper stage 41 and arranged to face the blanket BL are imaged through the transparent windows 815 of the lower stage 81 by the alignment cameras 27 arranged below the lower stage 81. It is the same as in the first embodiment that the precise alignment process is realized by moving the alignment stage 801 based on a positional relationship of the imaged alignment marks.

When the position alignment of the substrate SB held by the upper stage 41 and the blanket BL held on the lower stage 81 is completed in this way, the blanket BL is pushed up and brought into close contact with the substrate SB, thereby transferring the pattern. Specifically, by moving the transfer roller 841 upward after moving the transfer roller 841 to the initial position directly below the (−X) side end part of the substrate SB as shown in FIG. 20A, the blanket BL is pushed up by the transfer roller 841 and brought into contact with the lower surface of the substrate SB as shown in FIG. 20B.

The transfer roller 841 is moved in contact with the lower surface of the blanket BL in the (+X) direction. At this time, as shown in FIG. 20C, the lower stage 81 is moved in the same speed as and at the same speed as the transfer roller 841. Since this causes the transfer roller 841 and the lower stage 81 to move integrally in appearance in the (+X) direction, it is avoided that the lower stage 81 hinders an ongoing movement of the transfer roller 841. Further, since the blanket BL can be maintained in the horizontal posture immediately until being pushed up by the transfer roller 841, the pattern on the blanket BL can be transferred to a predetermined position on the substrate SB.

To enable such an operation, the grooves 814 provided on the lower stage 81 function as follows. Specifically, when the precise alignment process is finished, the supply of the negative pressure to the grooves 814 is stopped and vacuum suction of the blanket BL is released. At this point of time, the blanket BL is merely placed on the lower stage 81. Thus, the blanket BL is easily displaced upward and brought into close contact with the substrate SB by being pushed up by the transfer roller 841.

If a part of the blanket BL comes into close contact with the substrate SB, the positive pressure is supplied to the grooves 814 from the positive pressure supplier 707. The applied positive pressure is very small, but this forms a thin air layer between the lower surface of the blanket BL and the contact surface 811 of the lower stage 81 and the blanket BL is supported in a state slightly floated from the lower stage 81. By forming the air layer in this way, friction between the lower stage 81 and the blanket BL is fairly reduced and the lower stage 81 can be smoothly moved as the transfer roller 841 is moved.

If the supply of the positive pressure to the grooves 814 is started before the blanket BL is pushed up by the transfer roller 841, the blanket BL may horizontally move to cause a displacement between the blanket BL and the substrate SB. By supplying the positive pressure after the contact of the blanket BL and the substrate SB is started by the blanket BL being pushed up by the transfer roller 841, such a displacement can be avoided.

As shown in FIG. 20D, as the transfer roller 841 moves up to the (+X) side end part of the substrate SB, the entire substrate SB is held in close contact with the blanket BL and the pattern on the blanket BL is transferred to the substrate SB. Thereafter, as shown in FIG. 20E, the lift pins 831 are elevated up to a position directly below a laminate formed by uniting the substrate SB held by the upper stage 41 and the blanket BL and the vacuum holding of the substrate SB by the upper stage 41 is released, whereby the laminate is transferred from the upper stage 41 to the lifter unit 83. By further transferring the laminate to an external robot hand or the like, the pattern forming process is finished. Note that the laminate may be unloaded after the transfer roller 841 and the lower stage 81 are returned to original positions shown in FIG. 19A.

As described above, in this embodiment, the lower stage block 8 as a whole functions as the “first holder”. Further, the transfer roller 841 functions as the “push-up unit”.

### Third Embodiment

Next, a third embodiment of the pattern forming apparatus according to this invention is described. In the pattern forming apparatus of the third embodiment, the structure of a lower stage block partly differs from that of the pattern forming apparatus 1 of the first embodiment described above. On the other hand, other components in the first embodiment, i.e. the main frame 2, the upper stage block 4, the control unit 7 and the like can be basically applied as a main frame, an upper stage block, a control unit and the like in the third embodiment as they are. Accordingly, the following description is centered on points of difference from the first embodiment, particularly the structure and operation of the lower stage block. Further, the same components as in the first embodiment are denoted by the same reference signs and not described.

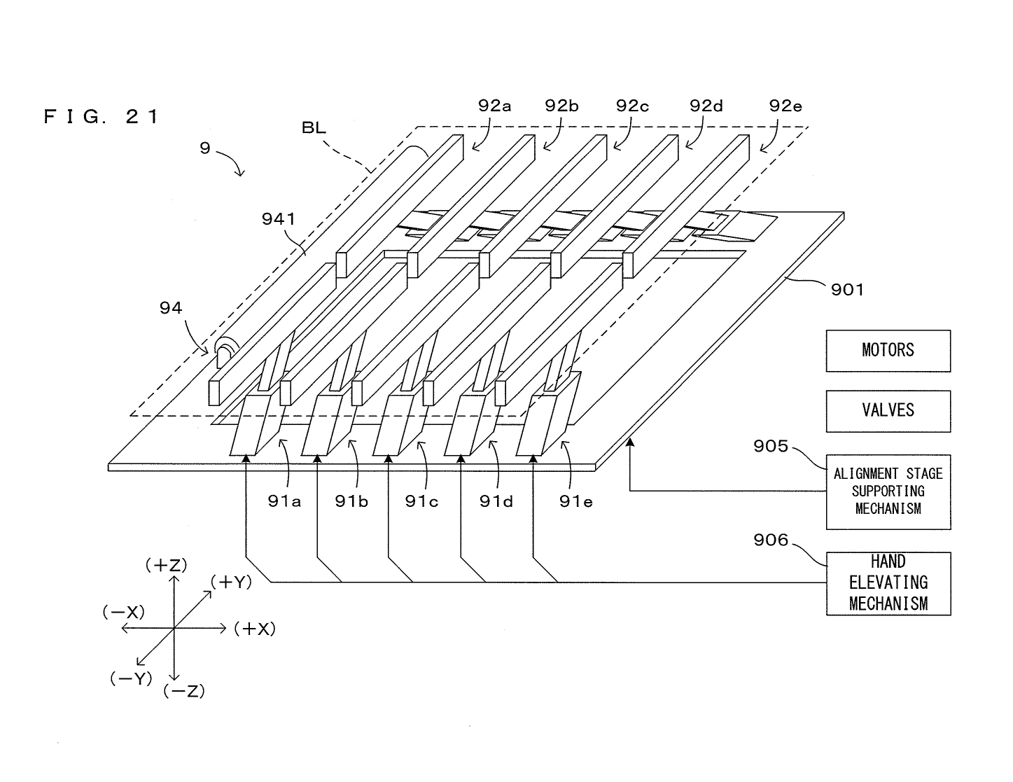

FIG. 21 is a view which shows a main part of the third embodiment of the pattern forming apparatus according to this invention. More specifically, FIG. 21 is a view showing the structure of a lower stage block 9 in the third embodiment. The lower stage block 9 includes an alignment stage 901. This alignment stage 901 corresponds to the alignment stage 601 in the first embodiment and the structure and functions thereof are also substantially the same. Specifically, the alignment stage 901 has a plate shape with an open central part and is supported on a base frame 21 (FIG. 1) movably within a predetermined range by an alignment stage supporting mechanism 905 having functions equivalent to those of the alignment stage supporting mechanism 605 of the first embodiment.

A plurality of support hand mechanisms are provided on the upper surface of the alignment stage 901. More specifically, five support hand mechanisms 91a, 91b, 91c, 91d and 91e are successively provided from an (−X) side toward a (+X) side on the upper surface of the alignment stage 901 on a (−Y) side with respect to a central aperture of the alignment stage 901. The structures of these five support hand mechanisms 91a, 91b, 91c, 91d and 91e are identical to each other.

On the other hand, five support hand mechanisms 92a, 92b, 92c, 92d and 92e are successively provided from the (−X) side toward the (+X) side on the upper surface of the alignment stage 901 on a (+Y) side with respect to the central aperture of the alignment stage 901. The structures of these five support hand mechanisms 92a, 92b, 92c, 92d and 92e are identical to each other. The support hand mechanisms 91a, 92a are symmetrically shaped with respect to an X axis and the functions thereof are the same. Further, each of the support hand mechanisms 91a, 91b, 91c, 91d and 91e is arranged at the same position in the X direction as the corresponding one of the support hand mechanisms 92a, 92b, 92c, 92d and 92e. Although described in detail later, these support hand mechanisms 91a, 91b, 91c, 91d, 91e, 92a, 92b, 92c, 92d and 92e cooperate to support a blanket BL in a horizontal posture in this embodiment.

A transfer roller unit 94 is provided on a (−X) side of and adjacent to the support hand mechanisms 91a, 92a located farthest on the (−X) side. A specific configuration of this transfer roller unit 94 is similar to that of the transfer roller unit 64 of the first embodiment. Specifically, the transfer roller unit 94 includes a transfer roller 941 whose axial direction is the Y direction and which is rotatably supported, and the transfer roller 941 is configured to be movable toward and away from the lower surface of the blanket BL by moving in the vertical direction (Z direction) and movable in contact with the lower surface of the blanket BL in the X direction. Similarly to the transfer roller 641 of the first embodiment, the transfer roller 941 has a function of realizing pattern transfer from the blanket BL to the substrate SB or patterning of a pattern forming material on the blanket BL by the plate PP by partially pushing up the blanket BL to bring the blanket BL into contact with a substrate SB (or plate PP).

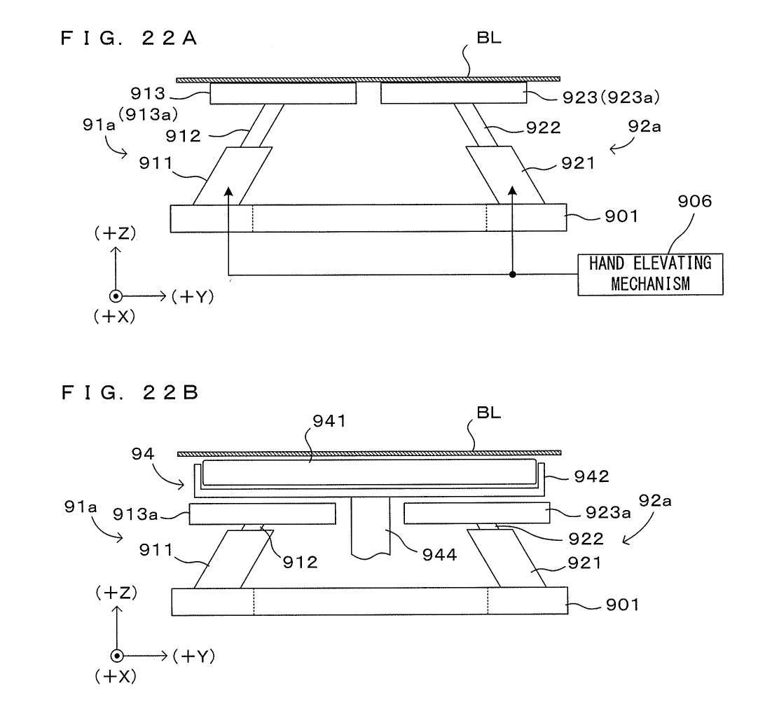

FIGS. 22A and 22B are views which show the detailed structure and movements of the support hand mechanisms. Here, one support hand mechanism 91a arranged on the (−Y) side of the alignment stage 901 and one support hand mechanism 92a arranged on the (+Y) side of the alignment stage 901 are taken as examples, but the support hand mechanisms 91b, 91c, 92 and 91e have the same structure as the support hand mechanism 91a and the support hand mechanisms 92b, 92c, 92 and 92e have the same structure as the support hand mechanism 92a as described above. Further, the support hand mechanism 92a is structured to be symmetrical to the support hand mechanism 91a with respect to the X axis.

As shown in FIG. 22A, the support hand mechanism 91a includes a base portion 911 extending obliquely upward toward the (+Y) side from the upper surface of the alignment stage 901, an arm 912 extending in the same direction as an extending direction of the base portion 911 from the base portion 911 and a blanket receiving member 913 coupled to the upper end of the arm 912 and having an upper surface horizontally extending along the Y direction. Similarly, the support hand mechanism 92a includes a base portion 921 extending obliquely upward toward the (−Y) side from the upper surface of the alignment stage 901, an arm 922 extending in the same direction as an extending direction of the base portion 921 from the base portion 921 and a blanket receiving member 923 coupled to the upper end of the arm 922 and having an upper surface horizontally extending along the Y direction.

The upper surfaces of the blanket receiving members 913, 923 are finished to be substantially flat and the positions thereof in the Z direction are the same. Accordingly, the support hand mechanisms 91a, 92a can integrally support the blanket BL from below and hold the blanket BL in a posture parallel to the Y axis. Note that suffixes (a to e) for distinguishing the support hand mechanisms are attached to the reference signs if it is necessary to distinguish the blanket receiving members 913 provided in the respective support hand mechanisms 91a to 91e. For example, the blanket receiving member provided in the support hand mechanism 91a is denoted by 913a. The same applies in the case of distinguishing the blanket receiving members 923 provided in the respective support hand mechanisms 92a to 92e.

The arm 912 of the support hand mechanism 91a is coupled to a hand elevating mechanism 906, and configured to be movable toward and away from the base portion 911 along the extending direction of the arm 912. Similarly, the arm 922 of the support hand mechanism 92a is coupled to the hand elevating mechanism 906, and configured to be movable toward and away from the base portion 921 along the extending direction of the arm 922. The hand elevating mechanism 906 integrally moves two arms 912, 922 back and forth in response to a control command from a control unit 7 (FIG. 2). This causes the blanket receiving members 912, 922 to move in the Z and Y directions with a horizontal posture maintained and the heights thereof aligned.

As just described, in a pair of support hand mechanisms 91a, 92a located at the same position in the X direction, the blanket receiving members 913 (913a), 923 (923a) thereof are integrally elevated and lowered. Similarly, blanket receiving members 913, 923 are elevated and lowered while maintaining the same position in a height direction (Z direction) between the support hand mechanisms 91b and 92b, between the support hand mechanisms 91c and 92c, between the support hand mechanisms 91d and 92 d and between the support hand mechanisms 91e and 92e located at the same positions in the X direction. However, the hand elevating mechanism 906 is so configured that the arms 912 (or arms 922) can be elevated and lowered independently of each other among the support hand mechanisms 91a, 91b, 91c, 91d and 91e (or among the support hand mechanisms 92a, 92b, 92c, 92d and 92e) located at mutually different positions in the X direction.

In a state where the blanket receiving members 913, 923 are positioned at an upper position shown in FIG. 22A by the hand elevating mechanism 906, the blanket receiving members 913, 923 support the blanket BL by coming into contact with the lower surface of the blanket BL. By positioning the blanket receiving members 913, 923 of the respective support hand mechanisms 91a to 91e, 92a to 92e at the same height, these can maintain the blanket BL in the horizontal posture as a unit.

A state where the blanket receiving members 913, 923 are, on the other hand, positioned at a lower position shown in FIG. 22B by the hand elevating mechanism 906 is described. If the blanket receiving members 913, 923 of the respective support hand mechanisms 91a to 91e, 92a to 92e are all lowered to the lower position, the blanket BL is supported in the horizontal posture at the upper surface position of the blanket receiving members 913, 923 at this time. However, the blanket receiving members 913 (or blanket receiving members 923) can be elevated and lowered independently of each other among the support hand mechanisms 91a, 91b, 91c, 91d and 91e (or among the support hand mechanisms 92a, 92b, 92c, 92d and 92e).

A state is considered where only the blanket receiving members 913, 923 of only some of the support hand mechanisms are at the lower position and the blanket receiving members of the other support hand mechanisms are at the upper position. Here, a case where only the blanket receiving members 913a, 923a of the support hand mechanisms 91a, 92a are at the lower position and the blanket receiving members 913, 923 of the other support hand mechanisms 91b to 91e, 92b to 92e are at the upper position is considered as an example.

In this case, the blanket BL is supported at the same position as the one shown in FIG. 22A by the blanket receiving members 913b to 913e, 923b to 923e located at the upper position. Thus, the blanket receiving members 913a, 923a of the support hand mechanisms 91a, 92a located at the lower position are separated and retracted downward from the blanket BL.

The arm 912 and the base portion 911 supporting the blanket receiving member 913a of the support hand mechanism 91a extend in the oblique direction and the blanket receiving member 913a moves in the (−Y) direction in addition to in the (−Z) direction when moving from the upper position to the lower position. Similarly, the blanket receiving member 923a of the support hand mechanism 92a moves in the (+Y) direction in addition to in the (−Z) direction when moving from the upper position to the lower position. As a result, two blanket receiving members 913a, 923a are positioned at the lower position in a state located at the same position in the Z direction and spaced more apart from each other than at the upper position in the Y direction.

The transfer roller unit 94 is enabled to enter a space formed between the lower surface of the blanket BL and the blanket receiving members 913a, 923a in this way. Specifically, the transfer roller 941 and a support frame 942 supporting this (corresponding to the support frame 642 in the first embodiment) are enabled to enter a clearance in the Z direction formed between the upper surfaces of the blanket receiving members 913a, 923a positioned at the lower position and the lower surface of the blanket BL. Further, a support leg 944 (corresponding to the support leg 644b in the first embodiment) supporting the support frame 942 is enabled to enter a clearance in the Y direction formed by the blanket receiving members 913a, 923a spaced apart from each other.

In such a configuration, in moving the transfer roller unit 94 in the X direction, it is possible to avoid the interference of the transfer roller unit 94 and the blanket receiving members 913, 923 by retracting the blanket receiving members 913, 923 located at a position on a path of the transfer roller unit 94 to the lower position. By positioning the blanket receiving members 913, 923, which are located at positions where they do not interfere with the transfer roller unit 94, at the upper position, the blanket BL can continue to be held in the horizontal posture at the constant height. Thus, as in the first embodiment, the transfer roller 941 can be horizontally moved along the lower surface of the blanket BL while the blanket BL is maintained in the horizontal posture also in this embodiment.

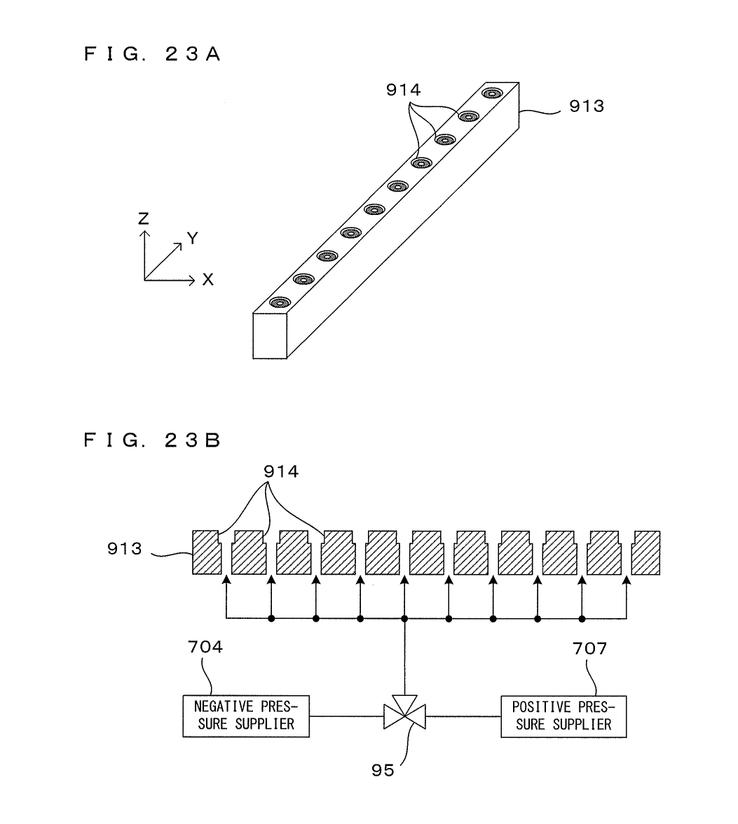

FIGS. 23A and 23B are views which show the more detailed structure of the blanket receiving member. More specifically, FIG. 23A is a perspective view showing the structure of an upper part of the blanket receiving member 913 and FIG. 23B is a sectional view of the blanket receiving member 913. Although one blanket receiving member 913 is described as an example here, the structure of the other blanket receiving member 923 facing this is the same.

The upper surface of the blanket receiving member 913 is finished to be flat and mirror polish finishing or lining using an appropriate material such as fluororesin is applied to reduce frictional resistance between the blanket BL and this upper surface. Further, a plurality of suction holes 914 for sucking and holding the lower surface of the blanket BL are provided on the upper surface of the blanket receiving member 913. As shown in FIG. 23B, a negative pressure supplied from a negative pressure supplier 704 of a control unit 7 and a positive pressure supplied from a positive pressure supplier 707 provided in the control unit 7 in this embodiment are selectively supplied to each suction hole 914 by a three-way valve 95. When the negative pressure is supplied to each suction hole 914 from the negative pressure supplier 704, the blanket BL is sucked and held onto the upper surface of the blanket receiving member 913 by each suction hole 914. On the other hand, when the positive pressure is supplied to each suction hole 914 from the positive pressure supplier 707, the blanket BL is supported in a state slightly floated from the upper surface of the blanket receiving member 913 by gas injected from each suction hole 914. At this time, friction between the blanket receiving member 913 and the blanket BL is very small. Note that a function of floating the blanket BL by injecting the gas from the suction holes 914 in this way is not essential in the blanket receiving member 913.

Besides, the lower stage block 9 of this embodiment includes valves for controlling the supply and the stop of the positive pressure and the negative pressure to the suction holes 914 and motors for mechanically driving the respective components similarly to the lower stage block 6 of the first embodiment, and these are controlled by the control unit 7.

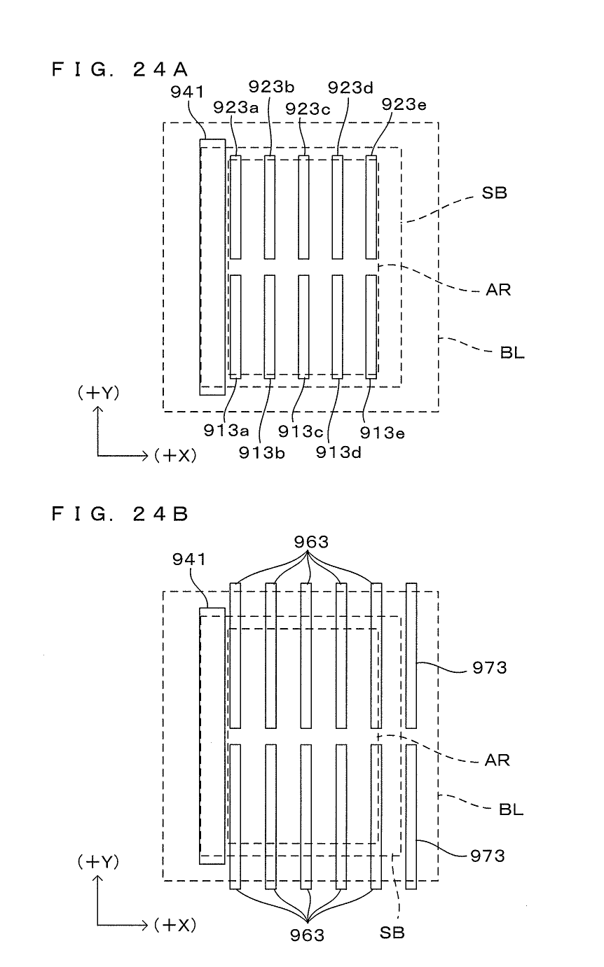

FIGS. 24A and 24B are views which show positional relationships of the blanket receiving members, the substrate and the blanket. As shown in FIG. 24A, a plurality of blanket receiving members 913, 923 are distributed and arranged at substantially equal intervals to entirely cover an effective area AR in a central part of the blanket BL and support, particularly, the lower surface of the effective area AR of the blanket BL. This causes the effective area AR to be held in a horizontal posture.

Note that how to support the blanket BL by the respective blanket receiving members 913, 923 outside the effective area AR is arbitrary as long as the blanket BL can be supported in the horizontal posture. For example, as shown in FIG. 24B, blanket receiving members 963 extending further outward than end parts of the blanket BL in the Y direction may be provided and blanket receiving members 973 which come into contact with the blanket BL only at an other side of the effective area AR may be provided.

As shown in FIG. 24A, the transfer roller 941 is at the (−X) side of and adjacent to the blanket receiving members 913a, 923a located farthest on the (−X) side out of the blanket receiving members 913, 923 when being positioned at a predetermined initial position. More specifically, at the initial position, the transfer roller 941 is separated from the blanket BL directly below the lower surface of the blanket BL at a position at the (−X) side of and adjacent to the blanket receiving members 913a, 923a, at the outer side, i.e. (−X) side of the effective area AR and closer to the (+X) side than the (−X) side end part of the substrate SB (or plate PP) held by the upper stage 41 as in the first embodiment. At this time, the transfer roller 941 is located below the substrate SB (or plate PP) at the outer side of the effective area AR.

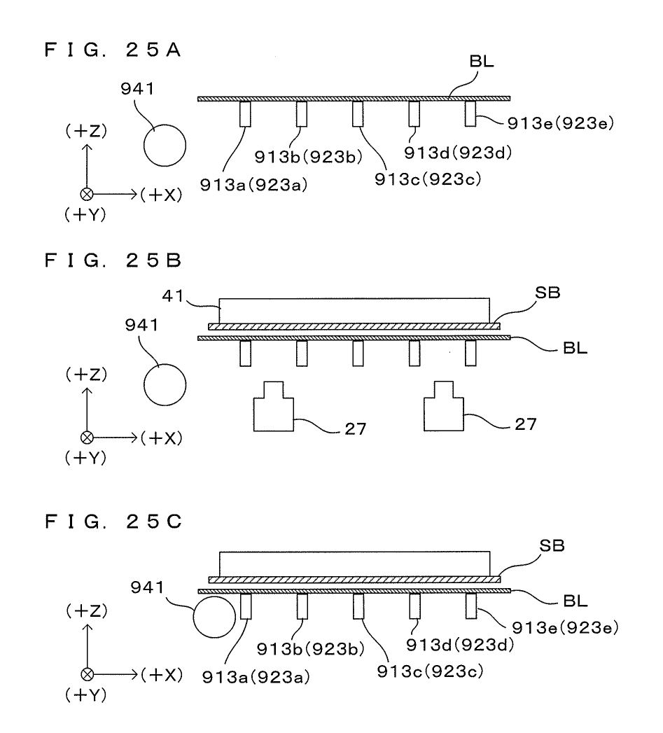

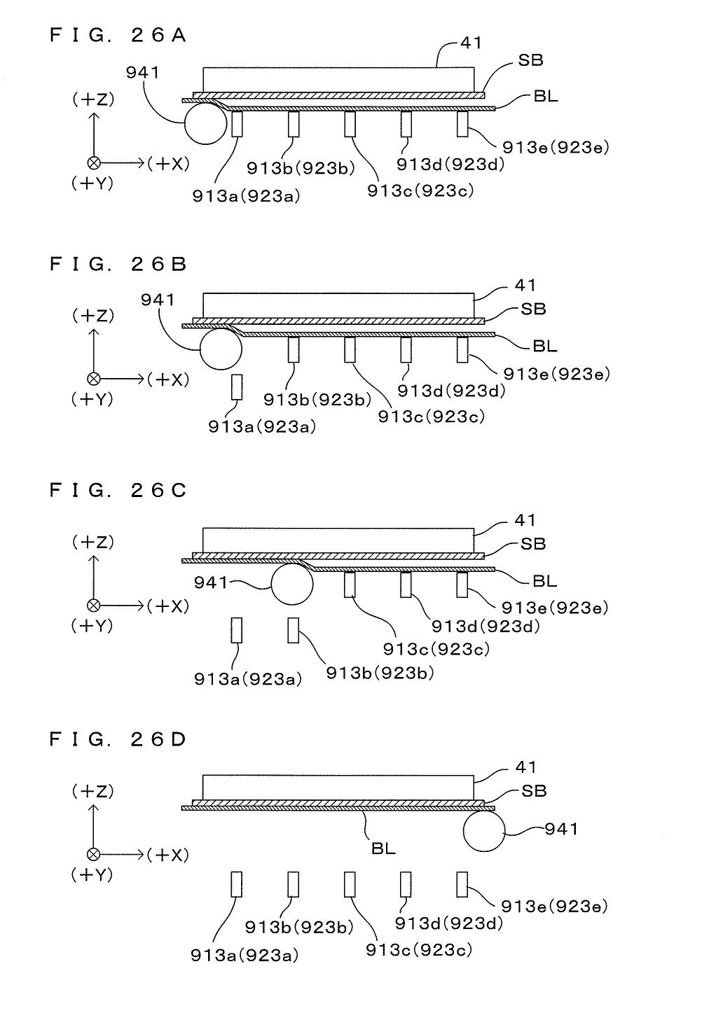

Next, the pattern forming process by the pattern forming apparatus of this embodiment are described. The purpose and basic operation of this process are similar to those of the process (FIG. 7) in the above first embodiment. However, the operation of each component constituting the lower stage block differs from that in the first embodiment due to a difference in the structure of the lower stage block. Specifically, a process of loading the substrate SB or the plate PP into the apparatus and holding it by the upper stage 41 is the same as in the first embodiment. On the other hand, a process until the blanket BL is loaded into the apparatus and brought into close contact with the substrate SB or the plate PP held by the upper stage 41 is different from that of the first embodiment. The following description is given centering on the process different from the first embodiment with reference to FIGS. 25A to 25C and 26A to 26D.

FIGS. 25A to 25C and 26A to 26D are views which diagrammatically show a positional relationship of each component of the apparatus in each stage of the pattern forming process of the third embodiment. Note that the operation of each component is described here when a substrate SB is held by the upper stage 41, a blanket BL already formed with a pattern is loaded onto the lower stage block 9 and a transfer process (Steps S107 to S112 of FIG. 7) is performed. However, as described in the first embodiment, an operation of performing a patterning process using the plate PP and the blanket BL (Step S101 to S105 of FIG. 7) is basically the same as the transfer process except that a precise alignment process is not performed. Thus, in the following description, an operation in the patterning process is also described by replacing the “substrate SB” by the “plate PP” and omitting the precise alignment process.

As shown in FIG. 25A, when the blanket BL is loaded from the outside, all the blanket receiving members 913a to 913e, 923a to 923e are positioned at the upper position. Accordingly, the blanket BL can be received from a hand for blanket (not shown) of an external conveyor robot or the like. Note that, at this time, the transfer roller 941 is positioned at a retracted position retracted further toward the (−X) side than the initial position shown in FIG. 24A to avoid interference with the hand for blanket and the blanket BL entering from the outside. Further, the negative pressure is supplied to the suction holes 914 provided on the upper surface of each blanket receiving member and the received blanket BL is sucked and held.

Subsequently, the gap adjustment and the pre-alignment process are performed. In the pre-alignment process, a peripheral edge part of the blanket BL is imaged by pre-alignment cameras for blanket 244 to 246 and the blanket BL is moved in a horizontal plane according to an imaging result, thereby being positioned at a target position similarly to the same process in the first embodiment. At this time, the alignment stage supporting mechanism 905 integrally moves the respective support hand mechanisms 91a to 91e, 92a to 92e in the X, Y and θ directions together with the alignment stage 901 to position the blanket BL.

Subsequently, the precise alignment process is performed. As shown in FIG. 25B, the blanket BL and the substrate SB held by the upper stage 41 and arranged to face the blanket BL are imaged through clearances between the blanket receiving members by the alignment cameras 27 arranged below the blanket BL. It is the same as in the first embodiment that the precise alignment process is realized by moving the alignment stage 901 based on a positional relationship of the imaged alignment marks.

When the position alignment of the substrate SB held by the upper stage 41 and the blanket BL held on the support hand mechanisms 91a to 91e, 92a to 92e is completed in this way, the blanket BL is pushed up and brought into close contact with the substrate SB, thereby transferring the pattern. Specifically, by moving the transfer roller 941 upward after moving the transfer roller 941 to the initial position directly below the (−X) side end part of the substrate SB as shown in FIG. 25C, the blanket BL is pushed up by the transfer roller 941 and brought into close contact with the lower surface of the substrate SB as shown in FIG. 26A. In this way, the transfer of the pattern on the blanket BL to the substrate SB is started.

Note that the blanket BL is sucked and held by supplying the negative pressure to the respective suction holes 914 of the blanket receiving members 913, 923 to prevent a displacement of the blanket BL relative to the support hand mechanisms 91a to 91e, 92a to 92e until the precise alignment process is finished after the blanket BL is loaded. On the other hand, the supply of the negative pressure to each suction hole 914 is stopped and suction holding is released before the transfer roller 941 starts pushing up the blanket BL.

Then, the transfer roller 941 is moved in contact with the lower surface of the blanket BL in the (+X) direction. At this time, as shown in FIGS. 26B and 26C, the blanket receiving members 913, 923 located at positions on the path of the transfer roller 941 where they interfere with the transfer roller 941 are successively retracted to the lower position in synchronization with the movement of the transfer roller 941. By doing so, the interference of the transfer roller 941 and the blanket receiving members 913, 923 is avoided. Movements of the blanket receiving members 913, 923 at this time are similar to those of the hands 625 in the first embodiment.

The blanket BL can be maintained in the horizontal posture by keeping the blanket receiving members 913, 923 in contact with the lower surface of the blanket BL immediately until the transfer roller 941 is pushed up. This enables the pattern on the blanket BL to be transferred to a predetermined position on the substrate SB. On the other hand, since being in close contact with the substrate SB in an area pushed up by the transfer roller 941, the blanket BL needs not be further supported by the blanket receiving members 913, 923. Thus, the blanket receiving members 913, 923 retracted to the lower position need not be returned to the upper position.

Note that the negative pressure may be supplied to the suction holes 914 immediately until each blanket receiving member 913, 923 starts moving to the lower position to prevent a displacement of the blanket BL in the horizontal direction as the blanket BL is pushed up by the transfer roller 941. In this case, each blanket receiving member 913, 923 needs to be so configured that a negative pressure supply timing is independently controllable.

The entire substrate SB is brought into close contact with the blanket BL and the pattern on the blanket BL is transferred to the substrate SB as shown in FIG. 26D while the blanket receiving members 913, 923 are successively retracted in this way. Thereafter, the transfer roller 941 is returned to an original position and each blanket receiving member 913, 923 is elevated to receive a laminate formed by uniting the substrate SB and the blanket BL from the upper stage 41. The laminate is further transferred to an external robot hand or the like, whereby the pattern forming process is finished.

As described above, in this embodiment, the support hand mechanisms 91a to 91e, 92a to 92a function, as a unit, as the “first holder”. Further, the transfer roller 941 functions as the “push-up unit”.

### <Miscellaneous>

Note that the present invention is not limited to the above embodiments and various changes other than the above ones can be made without departing from the gist thereof. For example, although the plate PP or the substrate SB and the blanket BL are both held by vacuum suction in the above embodiments, a holding mode is arbitrary without being limited to this.

For example, although the peripheral end parts of the four sides of the rectangular blanket BL are held by the annular lower stage 61 in the first embodiment, some of the peripheral end parts may not be held as long as the posture of the blanket is maintained. However, at least opposite end parts in the roller traveling direction (X direction) are preferably held to prevent a displacement associated with the travel of the roller.

For example, although the blanket BL is auxiliary supported from below by the hands 625 before being pressed by the transfer roller 641 in the above first embodiment, this is not essential. For example, if the size of the blanket BL is small, a deflection can be suppressed to be small only by holding the peripheral end parts in some cases. In such cases, auxiliary support is not particularly necessary. However, if the blanket is large in size, auxiliary support is effective to prevent damage caused by a deflection.

For example, in the above second embodiment, the suction holding of the blanket BL by the lower stage 81 is released after the blanket BL pushed up by the transfer roller 841 comes into contact with the substrate SB to prevent a displacement of the blanket BL in the horizontal direction due to the push-up by the transfer roller 841. In this case, particularly in an initial stage where a close contact area with the substrate SB is small, the blanket BL may move in the same direction as the transfer roller 841 horizontally moves. The following configuration may be, for example, adopted to prevent this.

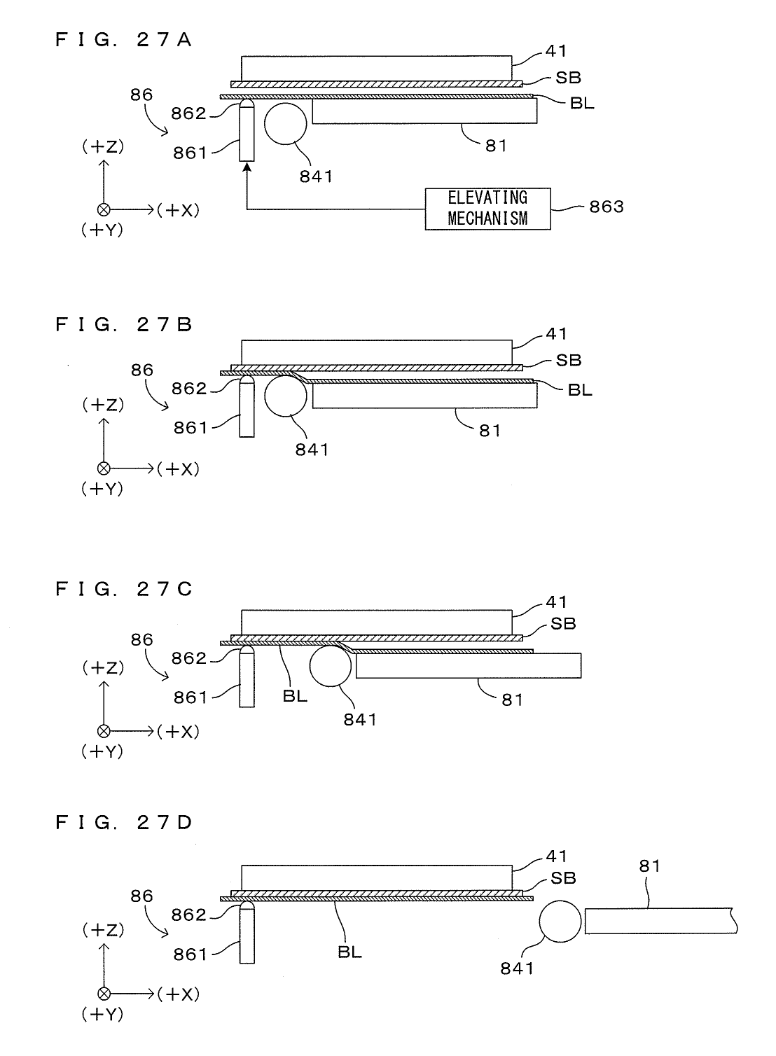

FIGS. 27A to 27D are views which show a modification of the second embodiment. In the following description, the same components as in the second embodiment are denoted by the same reference signs. As shown in FIG. 27A, in this modification, a blanket pressing mechanism 86 is provided at a position below the blanket BL supported on the lower stage 81 and directly below the (−X) side end part of the upper stage 41. The blanket pressing mechanism 86 includes a plate-like member 861 whose longitudinal direction is the Y direction and which is erected substantially in a vertical posture, an elastic member 862 which is mounted on the upper end of the plate-like member 861, and an elevating mechanism 863 which elevates and lowers the plate-like member 861 in response to a control command from the control unit 7.

As shown in FIG. 27B, when the transfer roller 841 moves upward and pushes up an end part of the blanket BL, the blanket pressing mechanism 86 also moves upward to a position where the upper end of the elastic member 862 is substantially at the same height as the upper end of the transfer roller 841. That is, at this time, the blanket BL is pushed against the substrate SB by being pushed upward by both the blanket pressing mechanism 86 and the transfer roller 841. In this state, the transfer roller 841 and the lower stage 81 are moved in the (+X) direction with the blanket pressing mechanism 86 kept in position as shown in FIG. 27C. At this time, since the blanket BL is not only held in close contact with the substrate SB, but also pressed against the substrate SB by the blanket pressing mechanism 86, a movement of the blanket BL in the horizontal direction, more specifically in the (+X) direction associated with the horizontal movement of the transfer roller 841 is avoided. This can prevent a displacement between the substrate SB and the pattern on the blanket BL. FIG. 27D shows the entire substrate SB held in close contact with the blanket BL.

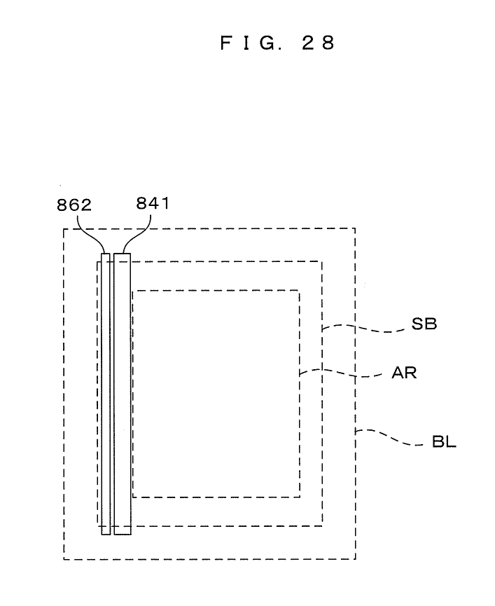

FIG. 28 is a view which shows contact positions of the blanket pressing mechanism and the transfer roller with the blanket in this modification. In an initial state shown in FIG. 27A, the transfer roller 841 is arranged between the plate-like member 861 of the blanket pressing mechanism 86 and the lower stage 81 in the X direction. As in the second embodiment, the transfer roller 841 first comes into contact with the lower surface of the blanket BL at the outer side, i.e. at the (−X) side of the effective area AR in the central part of the blanket BL. On the other hand, the blanket pressing mechanism 86 comes into contact with the blanket BL at the (−X) side of the transfer roller 841. To prevent the pressed blanket BL with an open upper side from being deformed upward, the pressed position is desirably at the (+X) side of the (−X) side end part of the substrate SB, more preferably at the (+X) side of the (−X) side end part of the upper stage 41 as shown in FIG. 27B.

Such a blanket pressing mechanism effectively functions also in the apparatus of the third embodiment for supporting the blanket BL by a multitude of support hand mechanisms and can more effectively prevent a displacement of the blanket BL.

As described above, in the present invention, an area of the lower surface of a blanket longer than an effective area along one axial direction is pushed up at once and a push-up position is moved in one direction from one end to the other end of the effective area in a direction perpendicular to the axial direction. To enable this, a push-up unit may be provided which includes a push-up roller extending in the axial direction and a mover which supports the push-up roller rotatably and moves in the direction perpendicular to the axial direction. By bringing a processing object and a blanket into contact in one direction from one end to the other end, the occurrence of defects such as a distortion of a pattern forming material and the entrance of bubbles between the processing object and the blanket can be prevented.

For example, a first holder may be configured to hold a peripheral end part of the blanket with the effective area open downward. Since the blanket is held with the central part of the lower surface corresponding to the effective area set in an open state in such a configuration, the holding of the blanket and the movement of the push-up unit are realized without the interference of the both.

At this time, it is preferable to hold at least peripheral end parts of opposite ends of the blanket in the direction perpendicular to the axial direction. By doing so, the blanket can be prevented from being displaced along a changing direction of the push-up position with a change in the push-up position. In terms of preventing a deflection, the peripheral end parts are more preferably held over the entire circumference of the blanket.

For example, the blanket may be placed and held on an annular holding frame which includes an aperture corresponding to the effective area and whose upper surface corresponding to a peripheral end part of the blanket is a flat surface. By holding the peripheral end part of the blanket by the annular holding frame, the peripheral end part of the blanket is held over the entire circumference. Thus, a deflection of the blanket due to its own weight and a displacement thereof when the blanket is pushed up can be effectively suppressed.

Further, an auxiliary holder may be further provided which partially comes into contact with the lower surface of the blanket. By doing so, the deflection of the blanket before the contact can be reduced and a gap amount between the blanket and the processing object can be easily controlled.

Further, the processing object may be held, for example, by bringing the upper surface of the processing object into contact with the lower surface of a plate-like member whose lower surface is a flat surface having a plane size larger than that of the processing object. By bringing the upper surface into contact with the plate-like member, the deflection of the processing object can be prevented and the deformation of the processing object due to contact with the pushed-up blanket can be prevented.

For example, the first holder may include a contactor whose upper surface serves as a flat contact surface having a larger plane size than the effective area of the blanket, the blanket may be held by bringing the contact surface into contact with the lower surface of the blanket, and the contactor may be configured to move in a moving direction of the push-up unit as the push-up unit is moved. According to such a configuration, the blanket can be held in a deflection-free state by bringing the lower surface of the blanket into contact with the contact surface and the interference of the contactor and the push-up unit is also avoided by a movement of the contactor as the push-up means is moved. The lower stage 81 functions as a “contactor” in the second embodiment.

Alternatively, for example, the first holder may include a plurality of local supporters for supporting the effective area of the blanket from a lower surface side by respectively locally coming into contact with the lower surface of the blanket and the local supporters may be arranged along the moving direction of the push-up unit and configured to be movable upward and downward independently of each other. The blanket receiving members 913, 923 function as a “local supporter” in the third embodiment.

According to such a configuration, the blanket can be held in the horizontal posture by the plurality of local supporters and the plurality of local supporters can independently move toward and away from the lower surface of the blanket. Since the blanket pushed up by the push-up unit and brought into close contact with the processing object needs not be supported from below, it suffices to support only a part not in contact with the push-up unit by the local supporters. If the local supporters located in an advancing direction of the push-up unit are successively retracted downward in accordance with the approach of the push-up unit, the blanket before being brought into contact with the push-up unit can be held in the horizontal posture while avoiding interference with the push-up unit.

Further, the effective area of the blanket held in contact with the processing object by being pushed up is preferably maintained in a state in contact with the processing object at least until the entire effective area comes into contact with the processing object. When the processing object and the blanket brought into contact with the processing object by being pushed up naturally separate from each other due to the release of the push-up, an unexpected shear force may be applied to the pattern forming material at a boundary between the contact part and the separated part to cause damage. To avoid this, it is effective to separate the both by an appropriately controlled method after the entire effective area of the blanket is brought into contact with the processing object.

Further, in the course of arranging the processing object and the blanket to face each other, the blanket is preferably loaded to a position below the processing object and caused to face the processing object after the processing object is positioned in a horizontal posture. By doing so, if a foreign matter such as dirt drops in the stage of positioning the processing object, the adhesion of this to the blanket can be prevented.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A pattern forming apparatus, comprising:
a first holder which holds a blanket carrying a pattern forming material on one surface in a horizontal posture with a carrying surface for the pattern forming material faced up;
a second holder which holds a plate for patterning the pattern forming material or a substrate, to which a pattern is transferred, as a processing object such that the processing object is proximate to and facing the carrying surface of the blanket held on the first holder; and
a push-up unit which partially pushes up an effective area in a central part of the blanket from a lower surface side of the blanket to bring the effective area into contact with the processing object held on the second holder and moves along the lower surface of the blanket to change a push-up position of the blanket.

2. The pattern forming apparatus of claim 1, wherein the push-up unit pushes up an area of the lower surface of a blanket longer than an effective area along one axial direction at once and moves in one direction from one end to an other end of the effective area in a direction perpendicular to the axial direction.

3. The pattern forming apparatus of claim 2, wherein the push-up unit includes a push-up roller extending in the axial direction and a mover which supports the push-up roller rotatably and moves in a direction perpendicular to the axial direction.

4. The pattern forming apparatus of claim 1, wherein the first holder holds a peripheral end part of the blanket with the effective area open downward.

5. The pattern forming apparatus of claim 4, wherein the first holder includes a holding frame having an annular shape to which an aperture corresponding to the effective area is disposed and whose upper surface corresponding to a peripheral end part of the blanket is a flat surface and holds the blanket placed on the holding frame.

6. The pattern forming apparatus of claim 1, comprising an auxiliary holder which partially comes into contact with the lower surface of the blanket.

7. The pattern forming apparatus of claim 1, wherein the second holder includes a plate-like member whose lower surface is a flat surface having a plane size larger than a plane size of the processing object and holds the processing object by bringing an upper surface of the processing object into contact with the lower surface of the plate-like member.

8. A pattern forming method, comprising:
a holding step of holding a plate for patterning a pattern forming material or a substrate, to which a pattern is transferred, as a processing object such that the processing object is held in a horizontal posture and holding a blanket which carries the pattern forming material on one surface in a horizontal posture with a carrying surface for the pattern forming material faced up so as to be proximate to and facing a lower surface of the processing object; and
a push-up step of partially pushing up an effective area in a central part of the blanket from a lower surface side of the blanket to bring the effective area into contact with the processing object and changing a push-up position of the blanket along the lower surface of the blanket.

9. The pattern forming method of claim 8, wherein in the holding step, a peripheral end part of the blanket is held with the effective area open downward.

10. The pattern forming method of claim 8, wherein in the push-up step, an area of the lower surface of the blanket longer than the effective area along one axial direction is pushed up at once and the push-up position is moved in one direction from one end to an other end of the effective area in a direction perpendicular to the axial direction.

11. The pattern forming method of claim 10, wherein in the holding step, a peripheral end parts of opposite ends of the blanket in a direction perpendicular to the axial direction.

12. The pattern forming method of claim 8, wherein in the push-up step, the effective area of the blanket held in contact with the processing object by being pushed up is maintained in a state in contact with the processing object at least until the entire effective area comes into contact with the processing object.

13. The pattern forming method of claim 8, wherein in the holding step, the blanket is loaded to a position below the processing object and caused to face the processing object after the processing object is positioned in a horizontal posture.

14. The pattern forming method of claim 8, wherein in the push-up step, the processing object is held by bringing an upper surface of the processing object into contact with a lower surface of a plate-like member whose lower surface is a flat surface having a plane size larger than a plane size of the processing object.
